(19) United States
(12) Patent Application Publication
(10) Pub. No.: US 2025/0299654 A1
(43) Pub. Date: Sep. 25, 2025

(54) DATA PROCESSING METHOD AND NON-TRANSITORY COMPUTER-READABLE STORAGE MEDIUM

(71) Applicant: YAMAHA CORPORATION, Hamamatsu-shi (JP)

(72) Inventors: Akira MAEZAWA, Yokohama-shi (JP); Kazuhiko YAMAMOTO, Hamamatsu-shi (JP); Masahiro SUZUKI, Yokohama-shi (JP); Ziyu WANG, Shanghai (CN)

(21) Appl. No.: 19/182,804

(22) Filed: Apr. 18, 2025

Related U.S. Application Data
(63) Continuation-in-part of application No. PCT/JP2023/037652, filed on Oct. 18, 2023.
(60) Provisional application No. 63/416,941, filed on Oct. 18, 2022.

(51) Int. Cl. G10H 1/00; G10H 1/36

(52) U.S. Cl. CPC G10H 1/0008; G10H 1/366; G10H 2210/036; G10H 2210/325

(57) ABSTRACT

There is provided a data processing method for an electronic musical instrument, the data processing method including: acquiring first sound control data, including pitch information, duration information, and a sound generation timing, from a first learned model to which performance data has been input; inputting the first sound control data and a parameter corresponding to first user setting information into a second learned model; and acquiring second sound control data from the second learned model.

### CROSS-REFERENCE TO RELATED APPLICATIONS

This application is a Continuation of International Patent Application No. PCT/JP2023/037652, filed on Oct. 18, 2023, which claims the benefit of priority to U.S. Patent Application No. 63/416,941, filed on Oct. 18, 2022, the entire contents of which are incorporated herein by reference.

### FIELD

The present invention relates to a technology for processing data.

### BACKGROUND

There is a known technology for displaying scores based on a performer's performance. For example, Japanese laid-open patent publication No. 2001-337675 discloses a device that determines and displays a performance portion in score data of a corresponding piece of music based on the pitch data of a sound.

### SUMMARY

According to an embodiment of the present invention, a data processing method for an electronic musical instrument is provided that includes acquiring first sound control data, including pitch information, duration information, and a sound generation timing, from a first learned model to which performance data has been input; inputting the first sound control data and a parameter corresponding to first user setting information into a second learned model; and acquiring second sound control data from the second learned model.

According to an embodiment of the present invention, a data processing method for an electronic musical instrument is provided that includes acquiring first sound control data, including pitch information, duration information, and a sound generation timing, from a first learned model to which performance data has been input; inputting the first sound control data into another learned model different from the first learned model; and acquiring score data from the other learned model.

According to an embodiment of the present invention, a data processing method for an electronic musical instrument is provided that includes acquiring first sound control data, including pitch information, duration information, and a sound generation timing, from a first learned model to which performance data has been input; acquiring desired tempo information; and generating a performance control signal based on the first sound control data and the desired tempo information.

According to an embodiment of the present invention, a data processing method for an electronic musical instrument is provided that includes acquiring first sound control data, including pitch information, note value information, and a sound generation timing, from a first learned model to which performance data has been input; inputting the first sound control data and a parameter corresponding to second user setting information into another learned model different from the first model; and acquiring image control data corresponding to the sound generation timing from the other learned model.

According to an embodiment of the present invention, a non-transitory computer-readable storage medium is provided that stores a program executable by a computer to execute any one of the data processing methods described above.

### BRIEF DESCRIPTION OF DRAWINGS

FIG. 1 is a diagram for explaining a system configuration in an embodiment.

FIG. 2 is a block diagram illustrating a configuration of an electronic musical instrument according to an embodiment.

FIG. 3 is a block diagram illustrating a configuration of a data processing device according to an embodiment.

FIG. 4 is a block diagram showing a configuration of an automatic music notation function according to an embodiment.

FIG. 5 is a block diagram showing a configuration of an automatic music notation function according to an embodiment.

FIG. 6 is a diagram illustrating a data processing method according to an embodiment.

FIG. 7 is a diagram illustrating a data processing method according to an embodiment.

FIG. 8 is a diagram illustrating a data processing method according to an embodiment.

FIG. 9 is a block diagram illustrating a configuration of a data processing unit according to another embodiment.

FIG. 10 is a block diagram showing a configuration of an automatic music notation function according to another embodiment.

FIG. 11 is a diagram illustrating a data processing method according to another embodiment.

FIG. 12 is a diagram illustrating a data processing method according to another embodiment.

FIG. 13 is a diagram illustrating a model generation function according to an embodiment.

FIG. 14 is a diagram illustrating a model generation function according to an embodiment.

FIG. 15 is a diagram illustrating a model generation function according to an embodiment.

FIG. 16 is a diagram illustrating a model generation function according to an embodiment.

FIG. 17 is a diagram illustrating a process of generating first sound control data.

FIG. 18 is a diagram illustrating a process of generating first sound control data.

FIG. 19 is a diagram illustrating a process of generating first sound control data.

FIG. 20 is a diagram illustrating a process of generating first sound control data.

FIG. 21 is a diagram illustrating a process of generating first sound control data.

FIG. 22 is a diagram illustrating a process of generating first sound control data.

FIG. 23 is a diagram illustrating a process of generating first sound control data.

FIG. 24 is a diagram illustrating a process of generating first sound control data.

FIG. 25 is a diagram illustrating a process of generating first sound control data.

FIG. 26 is a diagram illustrating a process of generating first sound control data.

FIG. 27 is a diagram illustrating a process of generating first sound control data.

FIG. 28 is a diagram illustrating a process of generating first sound control data.

FIG. 29 is a diagram illustrating a process of generating first sound control data.

FIG. 30 is a diagram illustrating a process of generating first sound control data.

FIG. 31 is a diagram illustrating a process of generating first sound control data.

FIG. 32 is a diagram illustrating a process of generating first sound control data.

FIG. 33 is a diagram illustrating a process of generating first sound control data.

FIG. 34 is a diagram illustrating a process of generating first sound control data.

FIG. 35 is a diagram illustrating a process of generating first sound control data.

FIG. 36 is a diagram illustrating a process of generating first sound control data.

FIG. 37 is a diagram illustrating a process of generating first sound control data.

FIG. 38 is a diagram illustrating a process of generating first sound control data.

FIG. 39 is a diagram illustrating a process of generating first sound control data.

FIG. 40 is a diagram illustrating a process of generating first sound control data.

FIG. 41 is a diagram illustrating a process of generating first sound control data.

FIG. 42 is a diagram illustrating a process of generating first sound control data.

### DESCRIPTION OF EMBODIMENTS

According to the present invention, Al can be used to automatically generate sound control data based on musical performances and perform desired processing on the generated sound control data according to the purpose.

An embodiment of the present invention will be described in detail below with reference to the drawings. The embodiments shown below are examples, and the present invention is not to be interpreted as limited to these embodiments. In the drawings to which reference is made in the present embodiment, the same or similar symbols (just a symbol with A, B, and the like, after a number) are added to the same part or a part having a similar function, and repeated explanations may be omitted.

### First Embodiment

### System Configuration

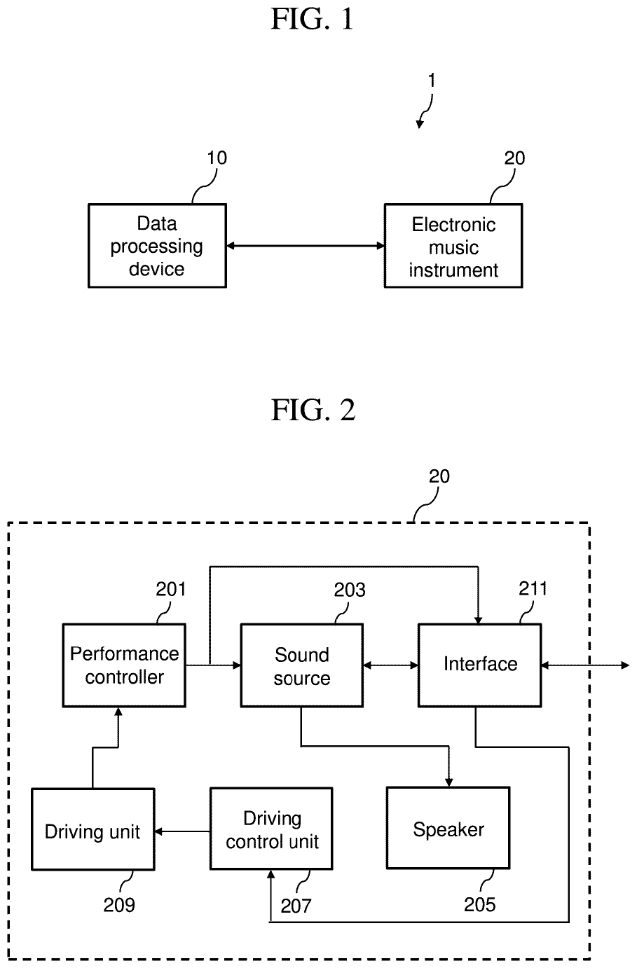

FIG. 1 is a diagram for explaining a system configuration in a first embodiment. A system 1 shown in FIG. 1 includes a data processing device 10 and an electronic musical instrument 20. In the system 1 shown in FIG. 1, the data processing device 10 and the electronic musical instrument 20 are connected each other, but the data processing device 10 and the electronic musical instrument 20 may be connected via a network such as the Internet.

For example, the data processing device 10 is a computer, such as a smartphone, a tablet computer, a laptop computer, or a desktop computer. In addition, the data processing device 10 may be a server connected to the electronic musical instrument 20 via a network. In this embodiment, the electronic musical instrument 20 is an electronic keyboard device such as an electronic piano.

When a user performs a predetermined performance operation on the electronic musical instrument 20, the data processing unit 10 generates sound control data based on the performance data output in response to the performance operation. The data processing unit 10 processes this sound control data for generating scores, automatically performing on the electronic musical instrument 20, adding a user's desired arrangement, and the like. A detailed description of the data processing unit 10 is described below.

### Electronic Musical Instrument

FIG. 2 is a block diagram illustrating a configuration of the electronic musical instrument 20. In this embodiment, the electronic musical instrument 20 is an electronic keyboard device such as an electronic piano. The electronic musical instrument 20 includes a performance controller 201, a sound source 203, a speaker 205, a driving control unit 207, a driving unit 209, and an interface 211. The performance controller 201 includes a plurality of keys and outputs a performance signal to the sound source 203 or the interface 211 in response to operations on each key. The performance signal is sound generation control information and is output sequentially in real time.

The sound source 203 includes a DSP (Digital Signal Processor). In the electronic musical instrument 20, in the case where a performance based on an operation to the performance controller 201 is executed, the sound source 203 generates reproduced sound data based on the performance signal and outputs it to the speaker 205. Furthermore, in the electronic musical instrument 20, in the case where a performance based on sound control data processed by the data processing unit 10 is executed, the sound source 203 generates the reproduced sound data based on the sound control data provided by the data processing unit 10 via the interface 211 and outputs it to the speaker 205. In this embodiment, the reproduced sound data is sound waveform data.

The speaker 205 converts the reproduced sound data provided by the sound source 203 into air vibrations and provides them to the user.

The driving control unit 207 generates a driving signal based on the sound control data provided by the data processing unit 10 via the interface 211 and outputs the generated driving signal to the driving unit 209. The driving unit 209 is a drive mechanism that operates the performance controller 201, for example, a solenoid.

The interface 211 includes a module for transmitting and receiving data to and from an external device wirelessly or via wires. In this embodiment, the interface 211 is connected to the data processing device 10 wirelessly or via wires, and sequentially transmits the performance signal output in response to the operation on the performance controller 201 to the data processing device 10. In addition, the interface 211 receives a performance control signal generated by the data processing unit 10 and outputs the received performance control signal to the sound source 203 and/or the driving control unit 207. cl Data Processing Device

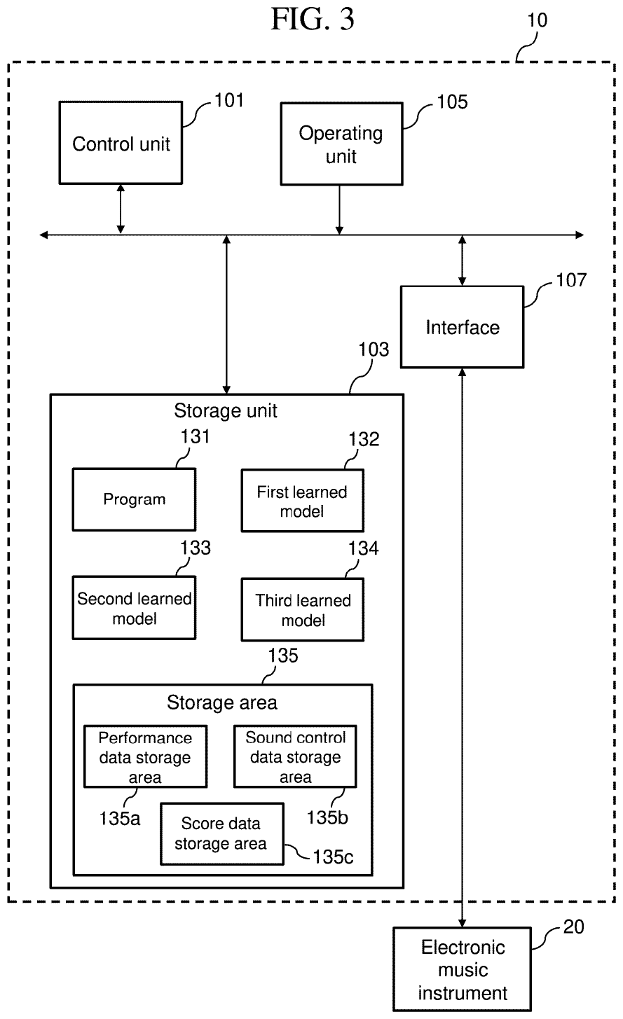

FIG. 3 is a block diagram illustrating a configuration of the data processing device 10. The data output device 10 includes a control unit 101, a storage unit 103, an operating unit 105, and an interface 107.

The control unit 101 is an example of a computer equipped with a processor such as a CPU and a storage device such as a RAM. The control unit 101 executes a program 131 stored in the storage unit 103 using the CPU (processor) to realize functions for executing various processes in the data processing device 10. The functions realized in the data processing unit 10 include an automatic music notation function described below. In addition, the functions realized in the data processing device 10 may further include a model training function.

The storage unit 103 is a storage device such as a RAM, a ROM, a nonvolatile memory, or a hard disk drive. The storage unit 103 stores the program 131 executed by the control unit 101 and various data required when executing the program 131. The storage unit 103 stores a plurality of learned models obtained by machine learning. The learned models stored in the storage unit 103 include a first learned model 132, a second learned model 133, and a third learned model 134. Furthermore, the storage unit 103 includes a storage area 135 for temporarily storing data and the like output from each learned model.

The program 131 may be installed in the data processing unit 10 by being downloaded from an external server via a network and stored in the storage unit 103. In addition, the program 131 may be provided as recorded on a non-transitory computer-readable storage medium (for example, a magnetic storage medium, an optical storage medium, a magneto-optical storage medium, a semiconductor memory, and the like). In this case, the data processing unit 10 only needs to be equipped with a device for reading this storage medium. The storage unit 103 is also an example of a storage medium. Details of the first learned model 132, the second learned model 133, and the third learned model 134 are described below.

The storage area 135 includes a storage device such as a RAM, and temporarily stores the data used in the processes executed by the data processing unit 10 and the data generated by the processes. In this embodiment, the storage area 135 includes a performance data storage area 135a, a sound control data storage area 135b, and a score data storage area 135c.

The performance data storage area 135a is an area for storing the performance signal sequentially provided from the electronic musical instrument 20 via the interface 107 as a single data file (performance data Pd). The performance signal is converted into sequence data in a predetermined format by the control unit 101 and stored in the performance data storage area 135a in association with time information. For example, the predetermined format is MIDI format. In other words, the performance signal is converted into data including sound generation control information including note-on, note-off, note-number, and the like, which define the contents of the sound generation obtained by a performer's performance, and stored in the performance data storage area 135a in association with the time information.

The sound control data storage area 135b is an area for temporarily storing first sound control data SC1 output from the first learned model 132 and second sound control data SC2 output from the second learned model 133, described below. Although not shown in the figure, the sound control data storage area 135b includes a first sound control data storage area and a second sound control data storage area. The first sound control data storage area temporarily stores the first sound control data SC1, and the second sound control data storage area temporarily stores the second sound control data SC2.

The first sound control data SC1 is output from the first learned model 132 in response to the input of the performance data Pd. Details of the first learned model 132 are described below. The first sound control data SC1 is data that includes pitch information, duration information, and a sound generation timing. The pitch information, the duration information, and the sound generation timing are defined for a single note and are associated with each other. The pitch information is information corresponding to the note number. The duration information is information indicating the length of the note in the score. In the present specification, the sound generation timing corresponds to a timing of a performance on the score, not the timing in absolute time. For example, the sound generation timing is information indicating a relative time defined by the number of measures, the number of beats, and the like. The sound generation timing can be converted into a timing in absolute time by determining a tempo (performance speed) of a piece of music. The pitch information, the duration information, and the sound generation timing are defined for each note that constitutes the piece of music.

The second sound control data SC2 is output from the second learned model 133 in response to the input of the first sound control data SC1. Details of the second learned model 133 are described below. Similar to the first sound control data SC1, the second sound control data SC2 is data that includes the pitch information, the duration information, and the sound generation timing.

The score data storage area 135c is an area for temporarily storing score data Sd output from the third learned model 134, which is described below. The score data Sd is output from the third learned model 134 in response to the input of the sound control data (the first sound control data SC1 or the second sound control data SC2). Details of the third learned model 134 are described below. The score data Sd is data for displaying the score generated based on the sound control data on a display device.

The operating unit 105 is an operation device that outputs a signal corresponding to a user's operation to the control unit 101. In the present embodiment, the signal corresponding to the user's operation includes user instruction information UI, tempo information, first user setting information UD1, and second user setting information UD2. The user instruction information UI is information indicating the process to be executed in the data processing device 10. The tempo information is information indicating a performance speed (tempo) of the piece of music. The first user setting information UD1 and the second user setting information UD2 are described below. The interface 107 includes a module for communicating with the external device wirelessly or by wired communication. In this embodiment, the external device includes the electronic musical instrument 20.

### Learned Models

The first learned model 132 is an arithmetic model used in converting the input performance data Pd of a specific piece of music into the first sound control data SC1. In the present embodiment, the first learned model 132 has two arithmetic models. The two arithmetic models correspond to a first encoder and a first decoder. A known machine learning model is applied to each of the arithmetic models. Different models may be applied to the two arithmetic models. For example, the known machine learning model is a model using a neural network utilizing a CNN (Convolutional Neural Network), an RNN (Recurrent Neural Network), and the like. The first sound control data SC1 is data to remove performance habits by the performer from the input performance data Pd and reproduce the score that is assumed to have been seen and played by the performer. The performance habits by the performer include the speed (slow and fast) of the performance, the strength and weakness of the music, and the like.

In other words, the first learned model 132 is a learned model acquired by machine learning a correlation between the performance data Pd and the first sound control data SC1. The correlation between the performance data Pd and the first sound control data SC1 indicates the correspondence between the sound generation control information of the performance data and that of the first sound control data SC1. The first learned model 132 is a learned model acquired by learning the performance contents when various performers played the piece of music. When the performance data Pd is input, the first learned model 132 outputs the first sound control data SC1 in response to the input data.

The second learned model 133 is an arithmetic model used when adding a user's desired arrangement to the first sound control data SC1. In the present embodiment, the second learned model 133 has three arithmetic models. The three arithmetic models correspond to a second encoder, a second decoder, and a third encoder. A known machine learning model is applied to each of the arithmetic models. For example, the known machine learning model is a model using a neural network utilizing the CNN, the RNN, and the like.

The second learned model 133 is a learned model acquired by machine learning the correlation between the first sound control data SC1 and the first user setting information UD1 and the second sound control data SC2. When the first sound control data SC1 and the first user setting information UD1 are input, the second learned model 133 outputs the second sound control data SC2 in response to the input data.

The first user setting information UD1 is input by the user via the operating unit 105. The first user setting information UD1 is information indicating a genre of performance desired by the user, specifically, a genre of the performance that the user wishes to reproduce. For example, the genre of the performance includes a performer desired by the user, and a music genre desired by the user, such as pop, jazz, rock, Latin, and the like. For example, in the case where the user desires to reproduce a performance by a predetermined performer (for example, a predetermined pianist), the first user setting information UD1 includes information indicating the performer desired by the user. Alternatively, in the case where the user desires a performance based on a predetermined music genre, the first user setting information UD1 includes information indicating the music genre desired by the user.

The second sound control data SC2 output by the second learned model 133 is the data in which the first sound control data SC1 is processed based on the first user setting information UD1. For example, in the case where the first user setting information UD1 includes information indicating the predetermined pianist, the second sound control data SC2 output by the second learned model 133 is arranged so that the performance habits of the predetermined pianist are added to the first sound control data SC1. Furthermore, for example, in the case where the first user setting information UD1 includes information indicating jazz, the second sound control data SC2 output by the second learned model 133 is arranged so that jazz characteristics are added to the first sound control data SC1.

The third learned model 134 is an arithmetic model used when generating the score data based on the sound control data. In the present embodiment, the third learned model 134 has two arithmetic models. The two arithmetic models correspond to a fourth encoder and a fourth decoder. A known machine learning model is applied to each of the arithmetic models. For example, the known machine learning model is a model using a neural network utilizing the CNN, the RNN, and the like.

In other words, the third learned model 134 is a learned model acquired by machine learning the correlation between the sound control data and the score data. When the sound control data is input, the third learned model 134 outputs the score data Sd in response to the input data. The sound control data input to the third learned model 134 is the first sound control data SC1 output from the first learned model 132 or the second sound control data SC2 output from the second learned model 133. The score data Sd output from the third learned model 134 is data for displaying the score.

### Automatic Music Notation Function

The automatic music notation function realized by the control unit 101 executing the program 131 will be described. At least a part of the automatic music notation function described below may be realized by other devices connected to the data processing unit 10 via a network. A plurality of devices connected via a network may work together to realize the automatic music notation function.

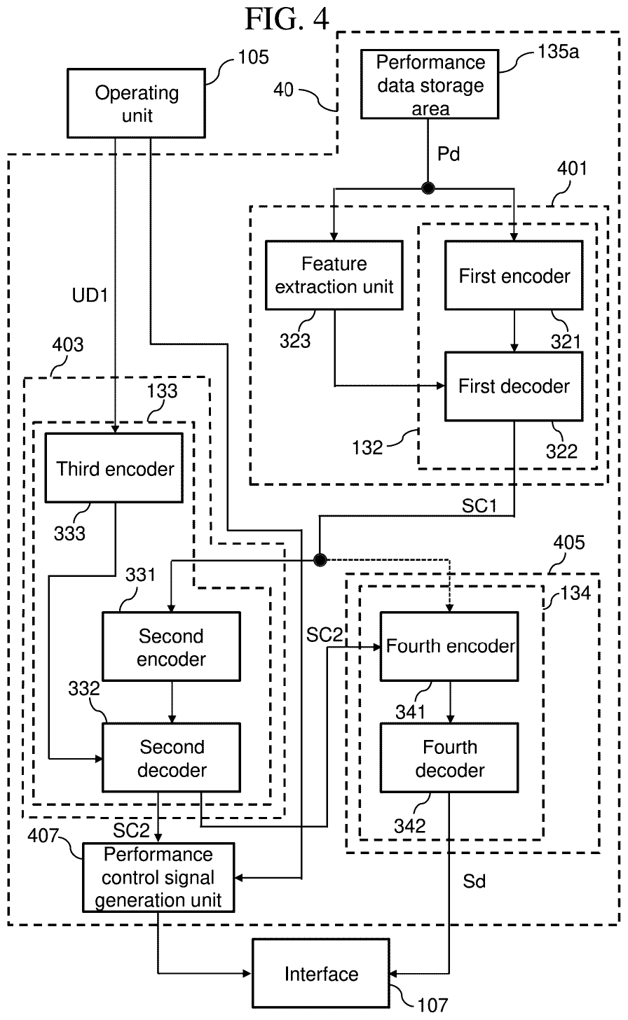

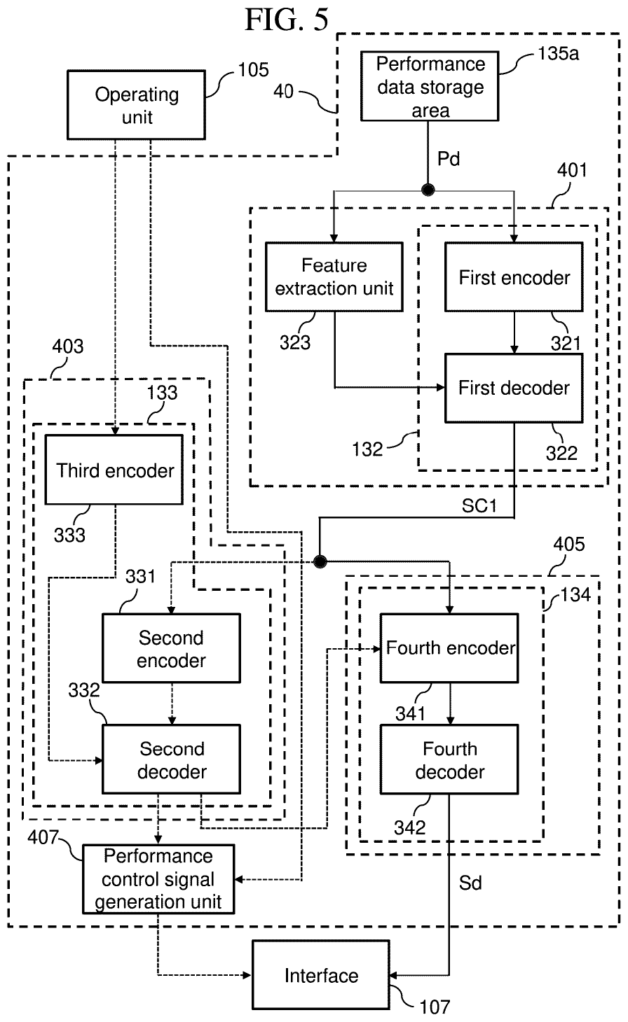

FIG. 4 and FIG. 5 are block diagrams of the automatic music notation function 40 in the present embodiment. The automatic music notation function 40 includes a first sound conversion unit 401, a second sound conversion unit 403, a score generation unit 405, and a performance control

The performance signal input from the electronic musical instrument 20 is stored as a single data file, the performance data Pd, associated with the time information in the performance data storage area 135a. The generated performance data Pd is input to the first sound conversion unit 401.

The first sound conversion unit 401 includes the first learned model 132 and a feature extraction unit 323. The first learned model 132 includes a first encoder 321 and a first decoder 322. The performance data Pd is provided to the first sound conversion unit 401 from the performance data storage area 135a. The performance data Pd is input to the first learned model 132. As described above, the first learned model 132 generates and outputs the first sound control data SC1 according to the input performance data Pd. The performance data Pd provided from the performance data storage area 135a is also input to the feature extraction unit 323. The feature extraction unit 323 extracts features of the sound contained in the provided performance data Pd and provides feature information indicating the features to the first decoder 322 of the first learned model 132. The feature information is used to generate the first sound control data SC1. Details of the first encoder 321 and the first decoder 322 of the first learned model 132 and the feature extraction unit 323 are described below. Although not shown in the figure, the first sound control data SC1 output from the first learned model 132 is temporarily stored in the first sound control data storage area of the sound control data storage area 135b and output to the second sound conversion unit 403 or the score generation unit 405.

FIG. 4 shows an aspect in which the first sound control data SC1 is output to the second sound conversion unit 403 based on the user instruction information UI. In this case, the user instruction information UI includes information indicating that the process for generating the second sound control data SC2 is to be executed. The second sound conversion unit 403 includes the second learned model 133. The second learned model 133 has a second encoder 331, a second decoder 332, and a third encoder 333. The first user setting information UD1 is input to the third encoder 333 by the user via the operating unit 105. The third encoder 333 outputs a parameter according to the input first user setting information UD1. This parameter is a vector value. The parameter output from the third encoder 333 is input to the second decoder 332.

The first sound control data SC1 is input to the second encoder 331. The second encoder 331 converts the input first sound control data SC1 into a vector value and outputs it. The vector value output from the second encoder 331 is input to the second decoder 332.

The vector value output from the second encoder 331 and the parameter according to the first user setting information UD1 output from the third encoder 333 are input to the second decoder 332. The second decoder 332 generates and outputs the second sound control data SC2 based on the input first sound control data SC1 and the parameter. Although not shown in the figure, the second sound control data SC2 output from the second learned model 133 is temporarily stored in the second sound control data storage area of the sound control data storage area 135b and output to the score generation unit 405 and/or the performance control

The score generation unit 405 includes the third learned model 134. The third learned model 134 includes a fourth encoder 341 and a fourth decoder 342. In the case where the second sound control data SC2 output from the second decoder 332 of the second learned model 133 is input to the score generation unit 405, the second sound control data SC2 is input to the fourth encoder 341. The fourth encoder 341 converts the input second sound control data SC2 into a vector value and outputs it. The vector value output from the fourth encoder 341 is input to the fourth decoder 342.

The vector value output from the fourth encoder 341 is input to the fourth decoder 342. The fourth decoder 342 generates and outputs the score data Sd based on the input vector value. Although not shown in the figure, the score data Sd output from the third learned model 134 is temporarily stored in the score data storage area 135c and provided via the interface 107 to a display device capable of displaying a score based on the score data Sd. The display device may be included in the electronic musical instrument 20. In this case, the score data Sd is provided to the electronic musical instrument 20. Alternately, the display device may be an external device different from the electronic musical instrument 20. In this case, the score data Sd is provided to the external device. The external device including the display device is a device capable of transmitting and receiving data to and from the data processing device 10. The external device may be a device capable of transmitting and receiving data to and from the data processing device via a network.

The second sound control data SC2 output from the second decoder 332 of the second learned model 133 can be input to the performance control signal generation unit 407 according to the user instruction information UI. The performance control signal generation unit 407 generates the performance control signal based on the second sound control data SC2 and the tempo information and outputs it to the electronic musical instrument 20.

As described above, the performance control signal is a MIDI format sound control signal generated based on the second sound control data SC2. The tempo information is input by the user via the operating unit 105 and indicates the performance speed (tempo) desired by the user. The performance control signal generated by the performance control signal generation unit 407 is sequentially transmitted via the interface 107 to the interface 211 of the electronic musical instrument 20 shown in FIG. 2, and provided to the sound source 203 and/or the driving control unit 207.

The sound source 203 generates the reproduced sound data based on the provided performance control signal. The reproduced sound data is a sound waveform signal based on the performance control signal. The sound source 203 outputs the reproduced sound data to the speaker 205. The speaker 205 converts the provided sound waveform signal into air vibrations and provides them to the user.

The driving control unit 207 generates a driving control signal based on the performance control signal. The driving control unit 207 outputs the generated driving signal to the driving unit 209. The driving unit 209 drives the performance controller 201 based on the driving signal.

This enables the electronic musical instrument 20 to reproduce or automatically play the performance sound based on the second sound control data SC2. As described above, the second sound control data SC2 is data arranged so that a user's desired feature is added to the first sound control data SC1 based on the first user setting information UD1. This enables the electronic musical instrument 20 to reproduce or automatically play the performance sound to which the user's desired feature is added for a predetermined piece of music.

FIG. 4 shows the aspect in which the first sound control data SC1 is output to the second sound conversion unit 403. However, the first sound control data SC1 output from the first learned model 132 may be output to the score generation unit 405 without passing through the second sound conversion unit 403.

FIG. 5 shows an aspect in which the first sound control data SC1 is output to the score generation unit 405. In this case, the user instruction information UI does not include information indicating that the process of generating the second sound control data SC2 is to be executed. In this example, the first sound control data SC1 is output to the score generation unit 405 without passing through the second sound conversion unit 403. The first sound control data SC1 is input to the fourth encoder 341 of the score generation unit section 405. The fourth encoder 341 converts the input first sound control data SC1 into a vector value and outputs it. The vector value output from the fourth encoder 341 is input to the fourth decoder 342.

The vector value output from the fourth encoder 341 is input to the fourth decoder 342. The fourth decoder 342 generates and outputs the score data Sd based on the input vector value. The score data Sd output from the third learned model 134 is temporarily stored in the score data storage area 135c and provided to the display device capable of displaying the score based on the score data Sd. As described above, the performance habits by the performer can be removed from the input performance data Pd, and a score based on the first sound control data SC1 can be generated to reproduce the score as it is assumed to have been seen and played by the performer.

In addition, although not shown in FIG. 5, the first sound control data SC1 may be output to the performance control signal generating unit 407 according to the user instruction information UI. In the case where the first sound control data SC1 is provided to the performance control signal generating unit 407, the performance control signal generating unit 407 generates the performance control signal based on the first sound control data SC1 and the tempo information and provides the performance control signal to the electronic musical instrument 20. This enables the electronic musical instrument 20 to reproduce or automatically play the performance sound reproducing the score that is assumed to have been seen and played by the performer for a predetermined piece of music.

The sound control data (the first sound control data SC1, the second sound control data SC2) and the score data Sd output from the first learned model 132, the second learned model 133, and the third learned model 134 are associated with each other and stored in the sound control data storage area 135b or the score data storage area 135c respectively. Therefore, for example, in the case where both the generation of the score data Sd and the generation of the performance control signal are included in the user instruction information UI, the display of the score based on the score data Sd and the driving of the performance controller based on the performance control signal can be synchronized with each other.

### Data Processing Method

A data processing method to be executed in the automatic music notation function 40 is described below. The data processing method described here is initiated when the program 131 is executed by the control unit 101.

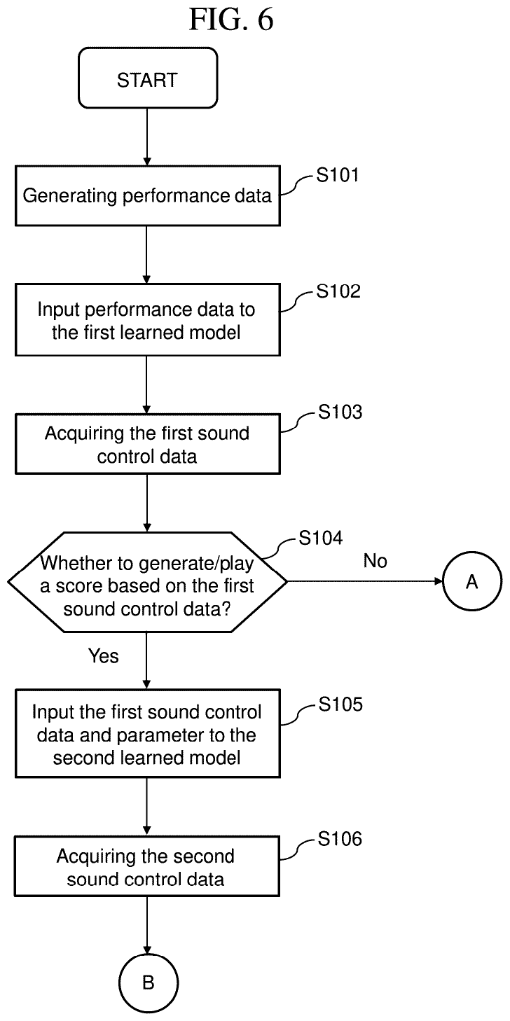

FIG. 6 to FIG. 8 are diagrams illustrating a data processing method according to the present embodiment. As shown in FIG. 6, the control unit 101 generates the performance data Pd based on the performance signal sequentially provided from the electronic musical instrument 20 (S101). The control unit 101 inputs the generated performance data Pd to the first learned model 132 (S102) and acquires the first sound control data SC1 (S103). The control unit 101 determines whether to generate and/or play a score based on the first sound control data SC1 based on the user instruction information UI previously input via the operating unit 105 (S104). In the case where the user instruction information UI includes the information instructing execution of a score generation process and/or a performance control signal generation process based on the first sound control data SC1 (S104; Yes), the control unit 101 inputs the first sound control data SC1 and the parameter based on the first user setting information UD1 into the second learned model 134 (S105), and acquires the second sound control data SC2 (S106).

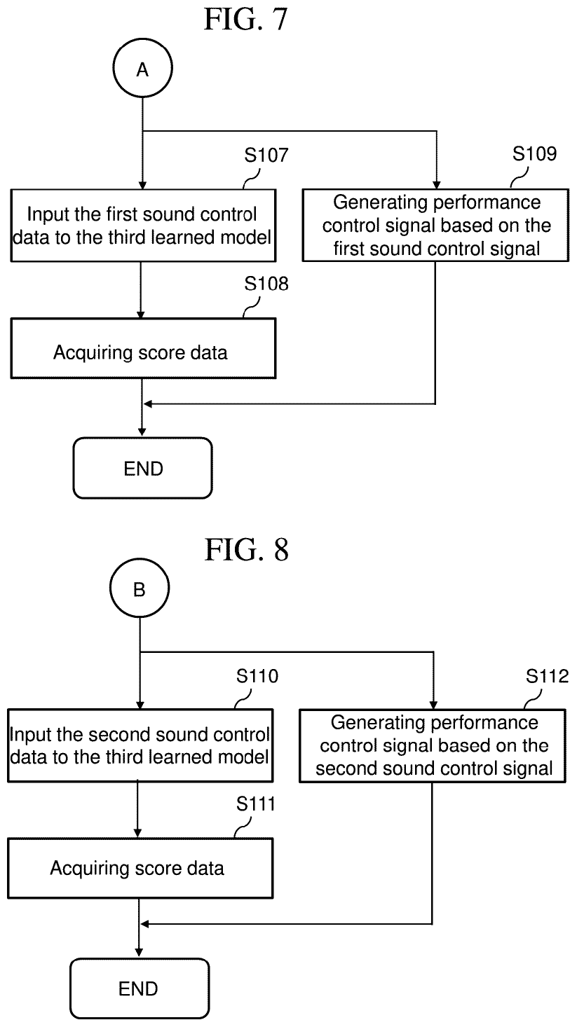

In the case where the user instruction information UI does not include the information instructing execution of the score generation process and/or the performance control signal generation process based on the first sound control data SC1 (S104; No), as shown in FIG. 7, the control unit 101 inputs the first sound control data SC1 to the third learned model 134 (S107) and acquires the score data Sd (S108). The control unit 101 also outputs the first sound control data SC1 to the performance control signal generation unit 407 to generate a performance control signal based on the first sound control data SC1 and the tempo information (S109). One of the processes of S107 to S108 and S109 may be executed, or both may be executed.

On the other hand, when the second sound control data SC2 is acquired by the process of S106, as shown in FIG. 8, the control unit 101 inputs the second sound control data SC2 to the third learned model 134 (S110), and acquires the score data Sd (S111). The control unit 101 also outputs the second sound control data SC2 to the performance control signal generation unit 407 to generate a performance control signal based on the second sound control data SC2 and the tempo information (S112). One of the processes of S110 to S111 and S112 may be executed, or both may be executed.

According to the above processing, it is possible to automatically generate the sound control data for score generation and/or automatic performance based on the performance signal, and further perform the desired processes according to the user's purpose. The generated sound control data can be used for various purposes.

The first sound control data SC1 is used for a score provision service, a training service, and the like. In the case where a score is generated based on the first sound control data SC1, it is possible to generate a score that is assumed to have been seen and played by the user, with the habits of the user who played the electronic music instrument 20 removed. By generating such a score, the score provision service can be realized. Furthermore, in the case where automatic performance based on the first sound control data SC1 is carried out, automatic performance based on the score assumed to have been played by the user can be realized on the electronic musical instrument 20. Such automatic performance can realize the training service. As described above, when the performance data Pd based on the performance signal is input to the first learned model 132, the first sound control data SC1 is output. This automatically acquires the first sound control data SC1 corresponding to the score that is assumed to have been seen and played by the user, and can provide a customer experience such as score generation and/or automatic performance based on this first sound control data SC1.

The second sound control data SC2 is used for the score provision service, the training service, the music generation service, and the like. In the case of generating a score based on the second sound control data SC2, it is possible to generate a score in which a user's desired arrangement is added to the score that is assumed to have been played by the user. By generating such a score, the score provision service can be realized. Furthermore, in the case where automatic performance based on the second tone control data SC2 is carried out, the electronic musical instrument 20 can realize the automatic performance based on the score in which the user's desired arrangement is added to the score assumed to have been played by the user. Such automatic performance can realize the training service and the music generation service. As described above, when the first sound control data SC1 and the first user setting information UD1 input from the user are input to the second learned model 133, the second sound control data SC2 is output. As a result, the second sound control data SC2, which is processed to add an arrangement based on the genre of performance desired by the user, is automatically acquired from the first sound control data SC1, and a customer experience such as score generation, automatic performance, and music generation based on this second sound control data SC2 can be provided.

Furthermore, in the case where the sound control data is used for the training service, for example, the performance data Pd based on the user's performance of the electronic music instrument 20 may be compared with the first sound control data SC1 or the second sound control data SC2, and comparison information indicating a comparison result may be generated by the data processing unit 10. In this case, an image based on the comparison information may be displayed on the display device so that the user can visually recognize the comparison result. This may provide a customer experience such that the user can visually recognize the difference between the user's own performance and the performance based on the first sound control data SC1 or the second sound control data SC2.

### Second Embodiment

The second embodiment of the present invention is described below. In the second embodiment, the storage unit in the data processing device includes a fourth learned model. The fourth learned model provides image control data based on the sound control data and a desired genre of action specified by the user. The data processing unit can generate image data for displaying an XR image based on this image control data. Since the configuration of the system 1 and the electronic musical instrument 20 in the second embodiment is similar to that of the first embodiment described with reference to FIGS. 1 and 2, duplicate descriptions are omitted.

### Data Processing Device

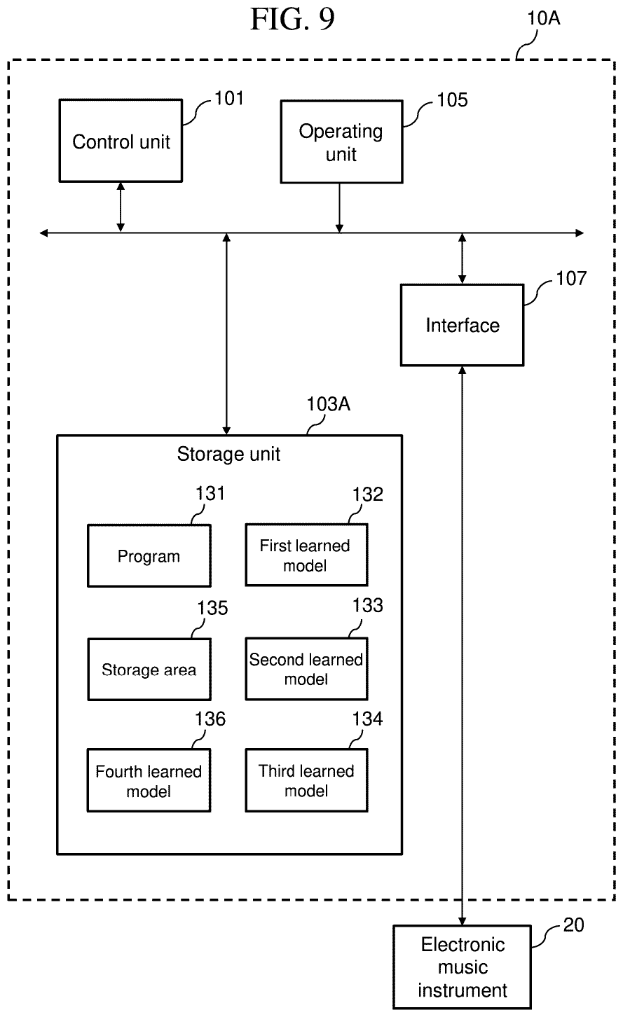

FIG. 9 is a block diagram illustrating a configuration of a data processing device 10A according to the second embodiment. The data processing device 10A includes the control unit 101, a storage unit 103A, the operating unit 105, and the interface 107. The configuration of the data processing device 10A, except for the storage unit 103A, is similar to that of the data processing device 10 according to the first embodiment. Therefore, a part of the storage unit 103A, which differs from the storage unit 103 in the first embodiment, is mainly described below.

The storage unit 103A stores a plurality of learned models acquired by machine learning. The learned models stored in the storage unit 103A include the first learned model 132, the second learned model 133, the third learned model 134, and a fourth learned model 136. The fourth learned model 136 is an arithmetic model used when generating motion image data for XR image display based on the sound control data and second user setting information UD2. In the present embodiment, the fourth learned model 136 has three arithmetic models. A known machine learning model is applied to each of the arithmetic models. For example, the known machine learning model is a model using a neural network utilizing the CNN, the RNN, and the like.

In other words, the fourth learned model 136 is a learned model acquired by machine learning the correlation between the sound control data and the second user setting information UD2 and the image control data. In this case, the sound control data is the first sound control data SC1 output from the first learned model 132 or the second sound control data SC2 output from the second learned model 133. The image control data is data for generating motion image data for XR image display. The image control data is information that indicates the action corresponding to the sound generation timing included in the sound control data. The second user setting information UD2 is information indicating the genre of action desired by the user, specifically, the genre of action that the user desires to be displayed in the image. In this case, for example, the genre of action includes the performer, conductor, or part of the body desired by the user. For example, in the case where the user desires the display of fingerings by a predetermined performer (for example, a predetermined pianist), the second user setting information UD2 includes information indicating the performer desired by the user and information indicating “both hands” as the body part to be displayed. Furthermore, in the case where the user desires the display of the posture during performance by a predetermined performer (for example, a predetermined pianist), the second user setting information UD2 includes information indicating the performer desired by the user and information indicating “whole body” as the body part to be displayed.

### Automatic Music Notation Function

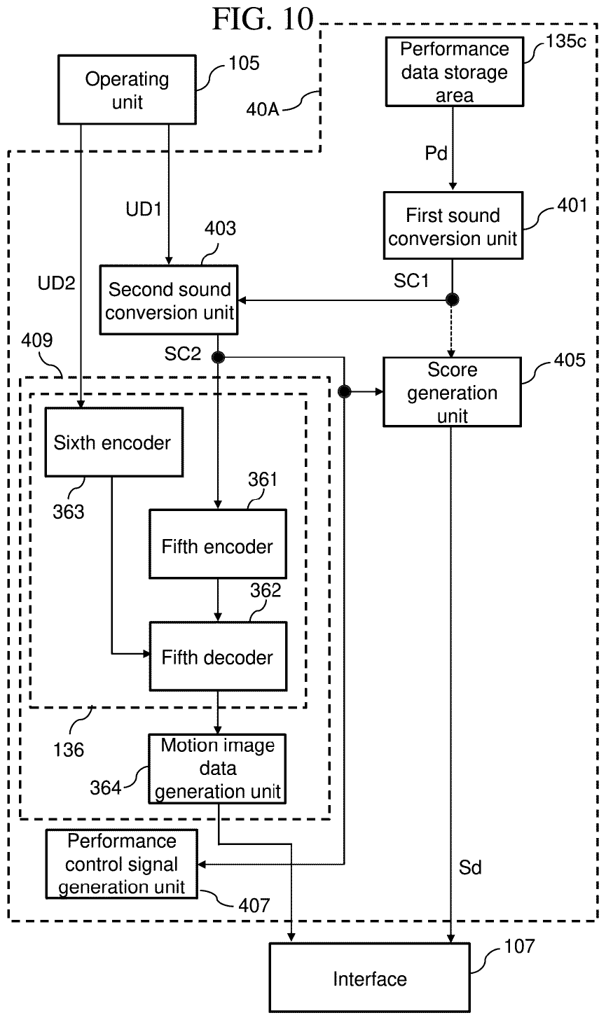

FIG. 10 is a block diagram showing a configuration of an automatic music notation function 40A. The automatic music notation function 40A includes the first sound conversion unit 401, the second sound conversion unit 403, the score generation unit 405, the performance control signal generation unit 407, and a motion image generation unit 409. Since the first sound conversion unit 401, the second sound conversion unit 403, the score generation unit 405, and the performance control signal generation unit 407 in the automatic music notation function 40A are similar to the first sound conversion unit 401, the second sound conversion unit 403, the score generation unit 405, and the performance control signal generation unit 407 in the automatic score 40 described in FIG. 4 and FIG. 5, the descriptions are omitted. Although not shown in the figure, the first sound conversion unit 401 includes the first learned model 132 and the feature extraction unit 323. Furthermore, although not shown in the figure, the second sound conversion unit 403 includes the second learned model 133. In addition, although not shown in the figure, the score generation section 405 includes the third learned model 134.

The motion image generation unit 409 includes the fourth learned model 136 and a motion image data generation unit 364. The fourth learned model 136 includes a fifth encoder 361, a fifth decoder 362, and a sixth encoder 363. The sound control data is provided to the fourth learned model 136. The sound control data input to the fourth learned model 136 is the first sound control data SC1 output from the first sound conversion unit 401 or the second sound control data SC2 output from the second sound conversion unit 403. In this case, the case where the sound control data input to the fourth learned model 136 is the second sound control data SC2 is explained as an example.

The second user setting information UD2 is input to the sixth encoder 363 of the fourth learned model 136 from the user via the operating unit 105. In the case where the user wishes to display the actions of a predetermined performer, the predetermined performer indicated by the information contained in the first user setting information UD1 input to the second learned model 133 of the second sound conversion unit 403 may be the same as the predetermined performer indicated by the information contained in the second user setting information UD2. The sixth encoder 363 outputs a parameter according to the input second user setting information UD2. This parameter is a vector value. The parameter output from the sixth encoder 363 is input to the fifth decoder 362.

The second sound control data SC2 is input to the fifth encoder 361. The fifth encoder 361 converts the input second sound control data SC2 into a vector value and outputs it. The vector value output from the fifth encoder 361 is input to the fifth decoder 362.

The vector value output from the fifth encoder 361 and the parameter according to the second user setting information UD2 output from the sixth encoder 363 are input to the fifth decoder 362. The fifth decoder 362 generates and outputs the image control data based on the input second sound control data SC2 and the input parameter. The image control data is information indicating the action corresponding to the sound generation timing included in the second sound control data SC2. The image control data output from the fourth learned model 136 is output to the motion image data generation unit 364.

The motion image data generation unit 364 generates motion image data based on the image control data output from the fourth learned model 136. The motion image data is display data for displaying the XR image. For example, the XR image is a VR image or an MR image. The motion image data generation unit 364 outputs the generated motion image data to the display device or a terminal that displays the XR image, such as external goggles or a head-mounted display. The terminal is a device capable of transmitting and receiving data to and from the data processing unit 10A, and may be capable of transmitting and receiving data to and from the data processing unit 10A via a network.

As described above, the image control data is information indicating the action corresponding to the sound generation timing included in the second sound control data SC2. Therefore, in the present embodiment, in the case where the performance control signal is generated in the performance control signal generation unit 407 based on the second sound control data SC2 and provided to the electronic musical instrument 20, the timing for sound generation based on the performance control signal and/or the timing for driving the performance controller 201 and the timing for displaying the XR image based on the motion image data can be synchronized.

In the above description, the case where the sound control data input to the fourth learned model 136 is the second sound control data SC2 was explained as an example. However, the sound control data input to the fourth learned model 136 may be the first sound control data SC1. In this case, the image control data is information indicating the action corresponding to the sound generation timing included in the first sound control data SC1.

### Data Processing Method

The data processing method executed in the automatic music notation function 40A is described below. The data processing method described here is initiated when the program 131 is executed by the control unit 101.

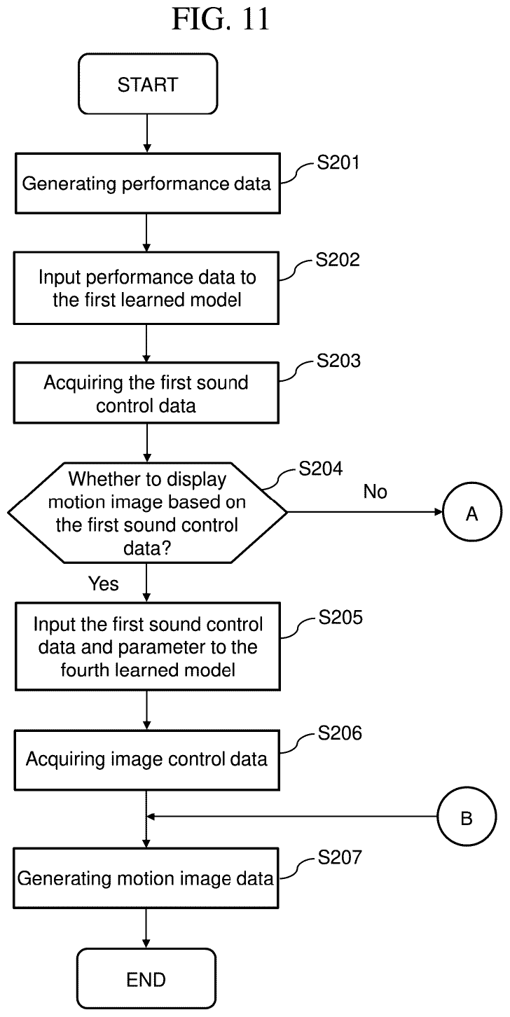

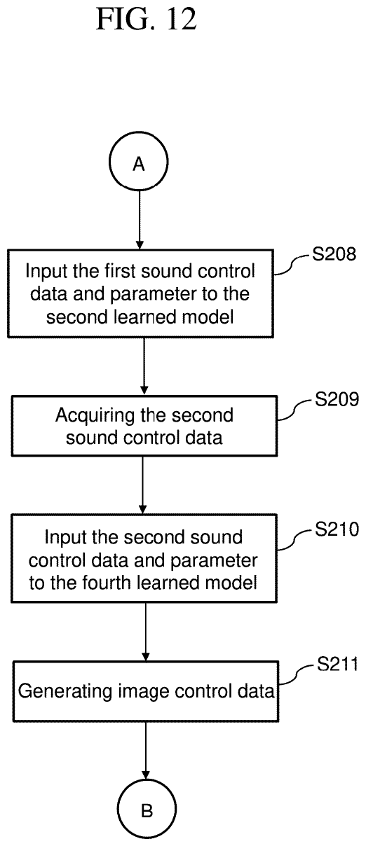

FIG. 11 to FIG. 12 are diagrams illustrating the data processing method according to the present embodiment. As shown in FIG. 11, the control unit 101 generates the performance data Pd based on the performance signal sequentially provided from the electronic musical instrument 20 (S201). The control unit 101 inputs the generated performance data Pd to the first learned model 132 (S202) and acquires the first sound control data SC1 (S203). The control unit 101 determines whether to generate a motion image based on the first sound control data SC1 based on the user instruction information UI previously input via the operating unit 105 (S204). In the case where the user instruction information UI includes information indicating that a motion image generation process based on the first sound control data SC1 is to be executed (S204; Yes), the control unit 101 inputs the first sound control data SC1 and the parameter based on the second user setting information UD2 into the fourth learned model 136 (S205) and acquires the image control data (S206). The control unit 101 inputs the image control data to the motion image data generation unit 364 to generate the motion image data based on the image control data (S207).

In the case where the user instruction information UI does not include information indicating that the motion image generation process based on the first sound control data SC1 is to be executed (S204; No), as shown in FIG. 12, the control unit 101 inputs the first sound control data SC1 and the parameter based on the first user setting information UD1 to the second learned model 133 (S208) and acquires the second sound control data SC2 (S209). Next, the control unit 101 inputs the second sound control data SC1 and the parameter based on the second user setting information UD2 to the fourth learned model 136 (S210) and acquires the image control data (S211). The control unit 101 inputs the image control data to the motion image data generation unit 364 to generate the motion image data based on the image control data (S207).

This makes it possible to automatically generate the image control data based on the first control data SC1 or the second sound control data SC2, and to display the motion image based on the image control data.

The processes of S201 to S203 shown in FIG. 11 correspond to the processes of S101 to S103 shown in FIG. 6. Although not shown in FIG. 11 and FIG. 12, the processes of S205 to S206 and the processes of S209 to S211 shown in FIG. 11 and FIG. 12 can be executed in parallel with the processes of S107 to S109 shown in FIG. 7 or the processes of S110 to S112 shown in FIG. 8.

According to the above processes, it is possible to automatically generate the sound control data for score generation and/or automatic performance and generate the user's desired motion image based on the sound control data. For example, the generated motion image is used for a training data service. The motion image may be displayed on a display device or external terminal in synchronization with the score or automatic performance based on the first sound control data SC1 or second sound control data SC2. This allows the user to visually recognize the fingering and body movements of the desired performer along with the score or automatic performance and use them as a model. As described above, the image control data is output when the first sound control data SC1 or the second sound control data SC2 and the second user setting information UD2 input by the user are input to the fourth learned model 136. As a result, the motion image based on the image control data is generated and a customer experience such that the user can modify the fingering and posture when playing is provided.

### Third Embodiment

The model generation function for generating the first learned model 132, the second learned model 133, the third learned model 134, and the fourth learned model 136 in the first embodiment and the second embodiment is described below. As described above, the first learned model 132, the second learned model 133, the third learned model 134, and the fourth learned model 136 are acquired by machine learning. In this case, the model generation function is realized by the control unit 101 in the data processing devices 10 and 10A realizing a predetermined program. The model generation function is realized for each of the first learned model 132, the second learned model 133, the third learned model 134, and the fourth learned model 136. The term “teacher data” described below may be replaced by the expression “training data”. The expression “learn the model” may be replaced by the expression “train the model”. For example, the expression “the computer uses the teacher data to learn the learning model” may be replaced with the expression “the computer uses the training data to train the training model. In addition, the model generation function may be executed by an external device such as a server that can communicate with the data processing devices 10 and 10A via a network.

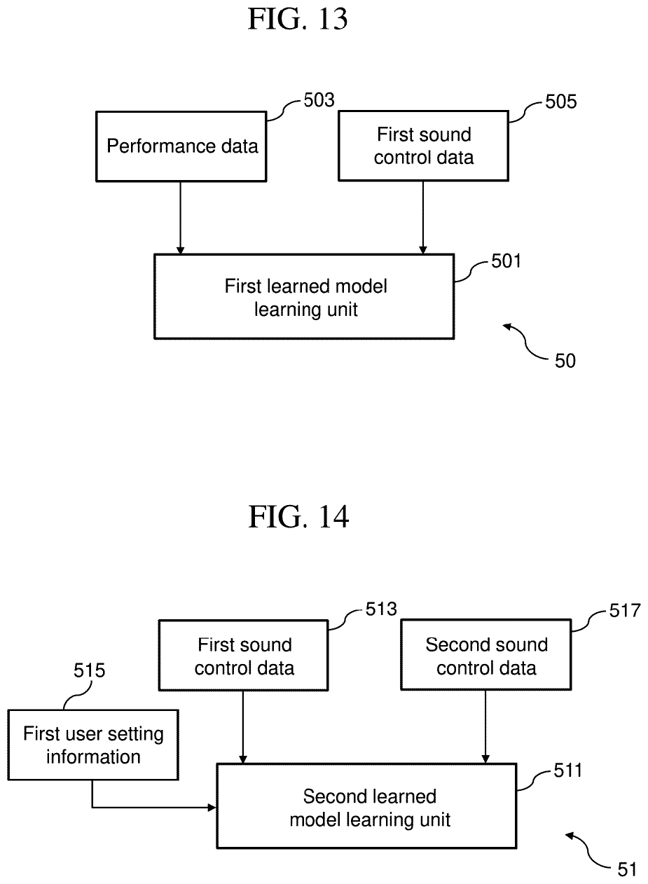

FIG. 13 is a diagram illustrating a model generation function 50 for generating the first learned model 132. The model generation function 50 includes a machine learning unit (a first learned model learning unit) 501. Performance data 503 and first sound control data 505 are provided to the machine learning unit 501. The performance data 503 corresponds to the performance data Pd described above, and the first sound control data 505 corresponds to the first sound control data SC1. The performance data 503 and the first sound control data 505 correspond to the teacher data in machine learning. The machine learning unit 501 uses the teacher data to execute machine learning to generate the first learned model 132. In other words, it can be said that the computer generates the first learned model 132 by training the learning model using the teacher data.

FIG. 14 is a diagram illustrating a model generation function 51 for generating the second learned model 133. The model generation function 51 includes a machine learning unit (a second learned model learning unit) 511. First sound control data 513, first user setting information 515, and second sound control data 517 are provided to the machine learning unit 511. The first sound control data 513 corresponds to the first sound control data SC1 described above, the first user setting information 515 corresponds to the first user setting information UD1, and the second sound control data 517 corresponds to the second sound control data SC2. The first sound control data 513, the first user setting information 515, and the second sound control data 517 correspond to the teacher data in machine learning. The machine learning unit 511 uses the teacher data to execute machine learning to generate the second learned model 133. In other words, it can be said that the computer generates the second learned model 133 by training the learning model using the teacher data.

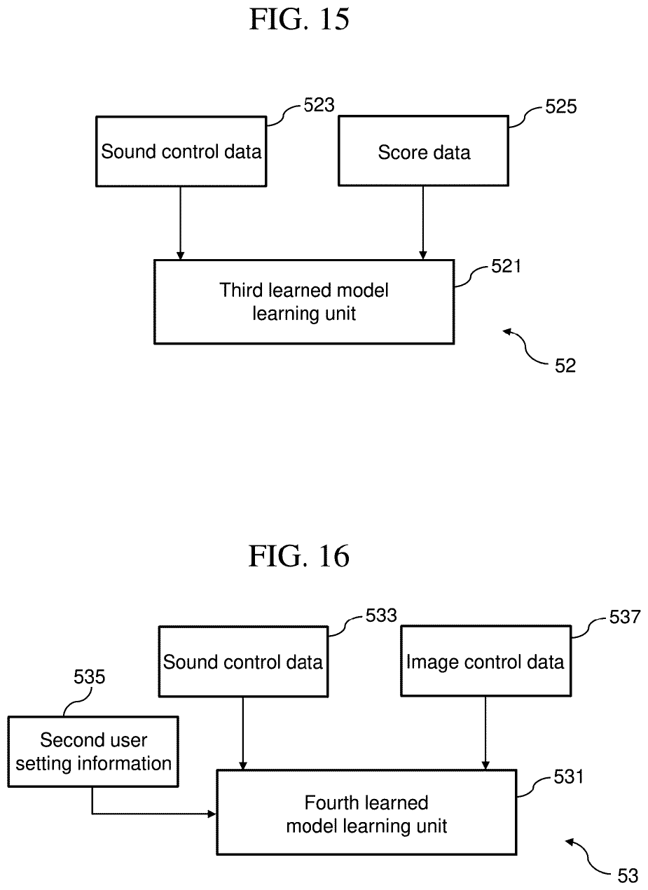

FIG. 15 is a diagram illustrating a model generation function 52 for generating the third learned model 134. The model generation function 52 includes a machine learning unit (a third learned model learning unit) 521. Sound control data 523 and score data 525 are provided to the machine learning unit 521. The sound control data 523 corresponds to the first sound control data SC1 and the second sound control data SC2 described above, and the score data 525 corresponds to the score data Sd. The sound control data 523 and the score data 525 correspond to the teacher data in machine learning. The machine learning unit 521 uses the teacher data to execute machine learning to generate the third learned model 134. In other words, it can be said that the computer generates the third learned model 134 by training the learning model using the teacher data.

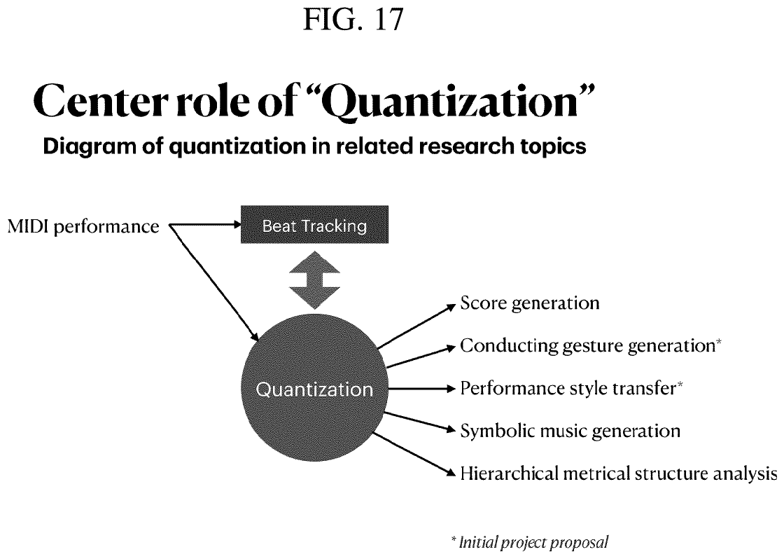

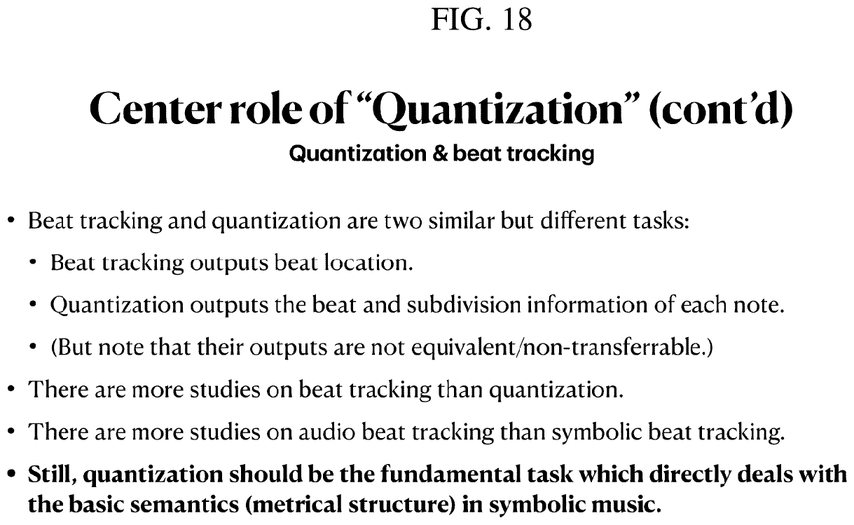

FIG. 16 is a diagram illustrating a model generation function 53 for generating the fourth learned model 136. The model generation function 53 includes a machine learning unit (a fourth learned model learning unit) 531. Sound control data 533, second user setting information 535, and image control data 537 are provided to the machine learning unit 531. The sound control data 533 corresponds to the first sound control data SC1 and the second sound control data SC2 described above, the second user setting information 535 corresponds to the second user setting information UD2, and the image control data 537 corresponds to information indicating the action corresponding to the sound generation timing included in the sound control data. The sound control data 533, the second user setting information 535, and the image control data 537 correspond to the teacher data in machine learning. The machine learning unit 531 uses the teacher data to execute machine learning to generate the fourth learned model 136. In other words, it can be said that the computer generates the fourth learned model 136 by training the learning model using the teacher data.

### Generation Process of First Sound Control Data

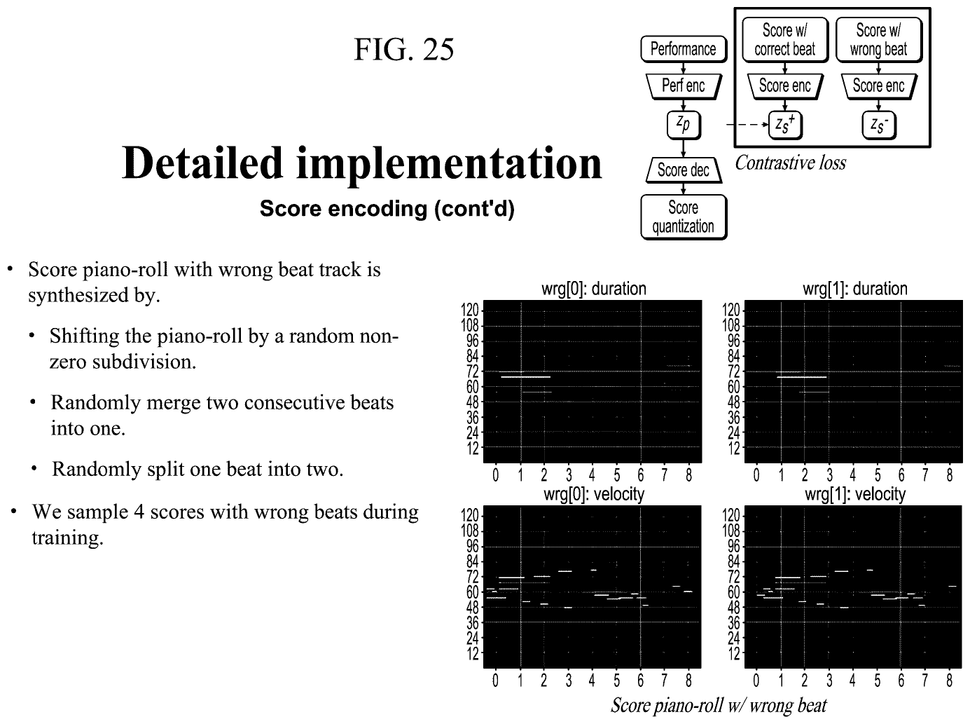

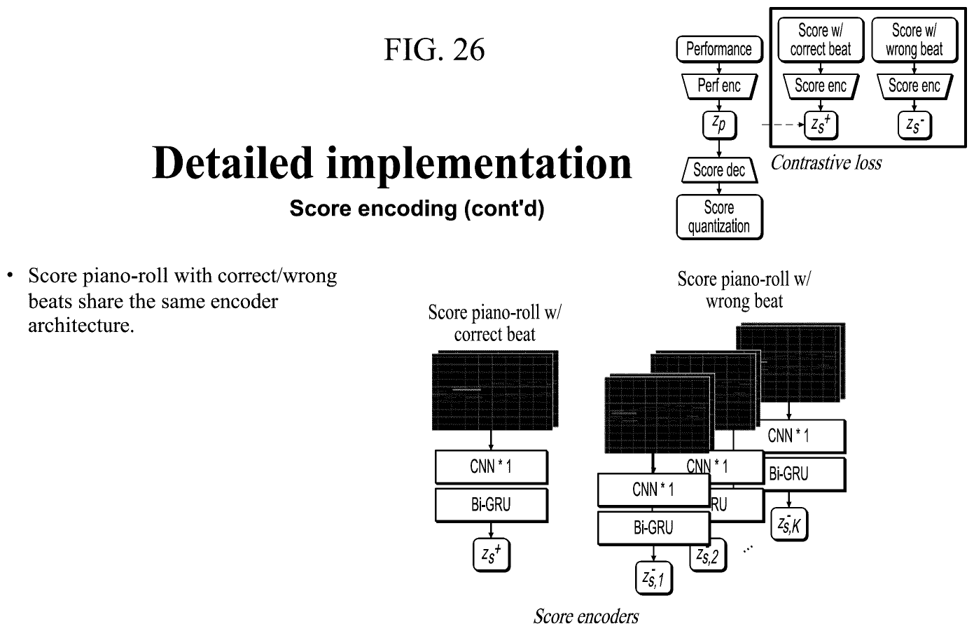

An overview of the process for generating the first sound control data SC1 by the first sound conversion unit 401 is described below. FIG. 17 to FIG. 42 are diagrams for explaining the process for generating the first sound control data. FIG. 17 to FIG. 42 and their descriptions include the contents described in U.S. Provisional Application No. 63/416,941.

As described above, the first sound control data SC1 is output in response to the input of the performance data Pd to the first learned model 132. The first sound control data SC1 includes data in which the pitch information, the duration information, and the sound generation timing are defined for a single note by quantization, and are associated with each other.

As shown in FIG. 17, the first sound control data SC1 acquired by quantizing the performance data (MIDI performance) is used for various purposes. For example, the first sound control data SC1 is used for processing such as generating scores, generating motion image data for displaying motion images, and adding arrangements desired by the user, as described in the first embodiment and the second embodiment above. In addition, the first sound control data SC1 may also be utilized for composition processing using a composition Al, beat analysis, etc.

FIG. 18 shows quantization (the role of quantization). As shown in FIG. 18, beat tracking and quantization are similar to each other, but are different tasks: beat tracking outputs the beat position, while quantization outputs detailed information about the beat and each sound (note). There is more research on beat tracking than on quantization, and there is more research on audio beat tracking than on symbolic beat tracking. However, quantization is a fundamental task that deals directly with the basic meaning (beat structure) in symbolic music.

The generation process of the first sound control data SC1 by the first sound conversion unit 401 is described below. As described above, the first learned model 132 of the first sound conversion unit 401 includes the first encoder 321 and the first decoder 322. The performance data Pd is input to the first encoder 321 and converted into the vector value.

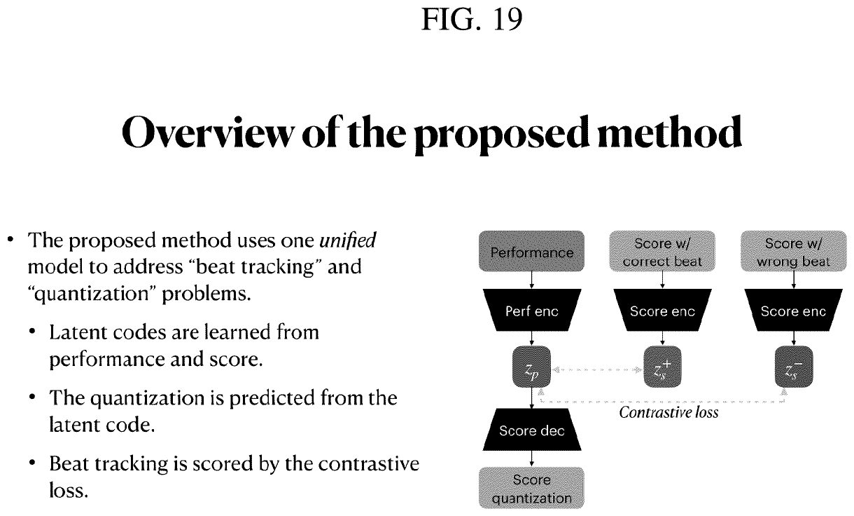

According to FIG. 19, the proposed method addresses the problems of “beat tracking” and “quantization” using one unified model. Latent codes are learned from performances and scores. Quantization is predicted from the latent code, and beat tracking is scored by a contrastive loss. In FIG. 19, “Performance” corresponds to the performance data Pd in the embodiments described above, “Perf enc” corresponds to the first encoder 321, “Score dec” corresponds to the first decoder 322, and “Score quantization” corresponds to the first sound control data SC1.

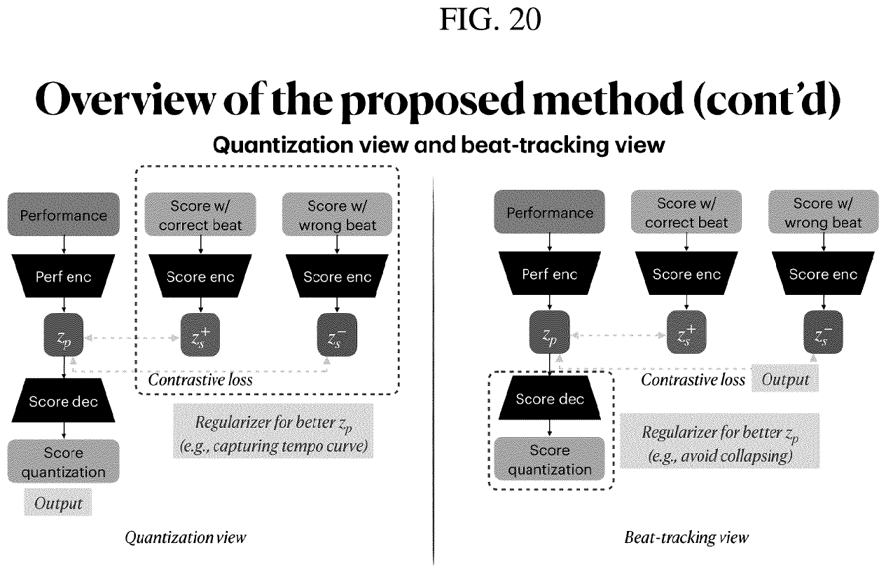

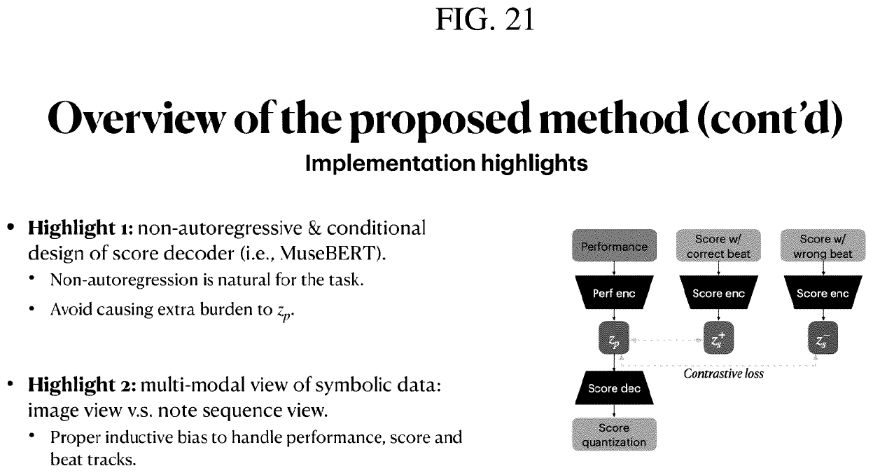

As shown in FIG. 20, the first encoder 321 converts the performance data Pd to a vector value Zp so that the value is close to a value Zs⁺ when the performance data based on the score that the performer is assumed to have seen and played is converted to a vector value.

FIG. 21 shows that the implementation features are a non-autoregressive and conditional design of a score decoder (MuseBERT) and a multi-modal view of symbolic data: image view and note sequence view.

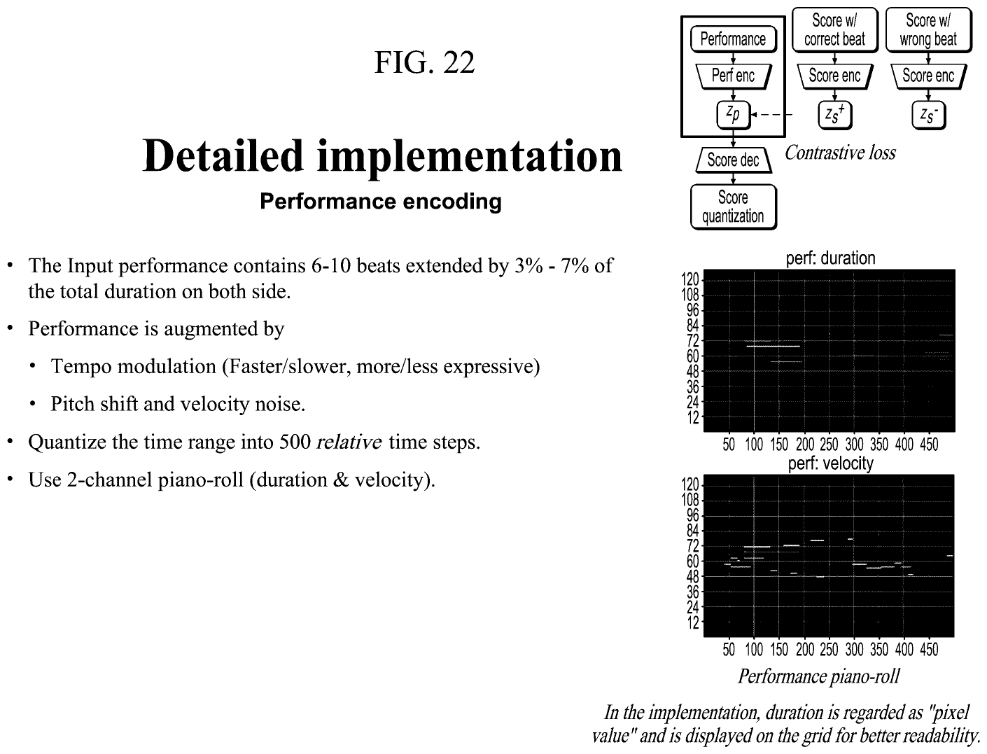

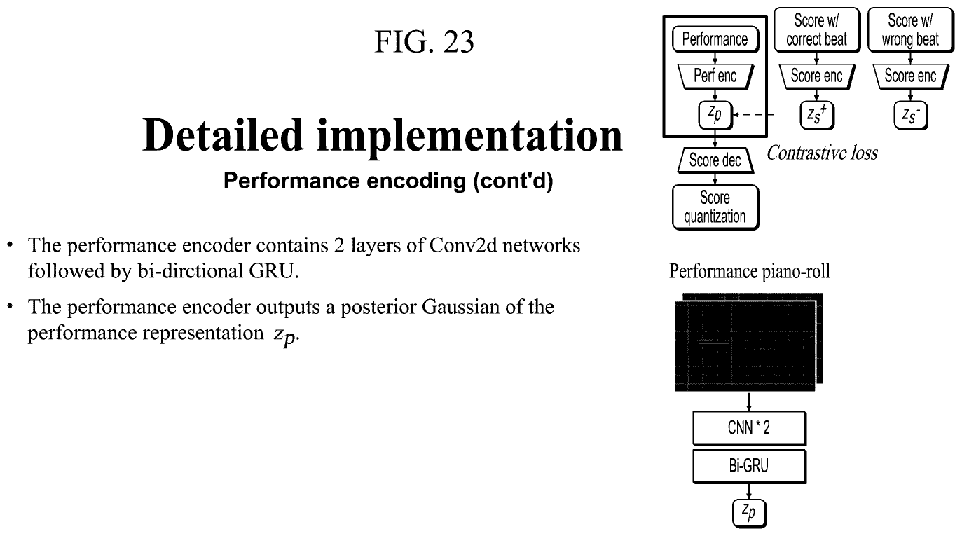

In detail, as shown in FIG. 22 and FIG. 23, based on the performance data, the duration (duration of sound generation) and velocity (intensity of sound) of each note are converted into the vector value. This conversion uses CNN*2 and Bi-GRU, the two layers included in the first encoder 321.

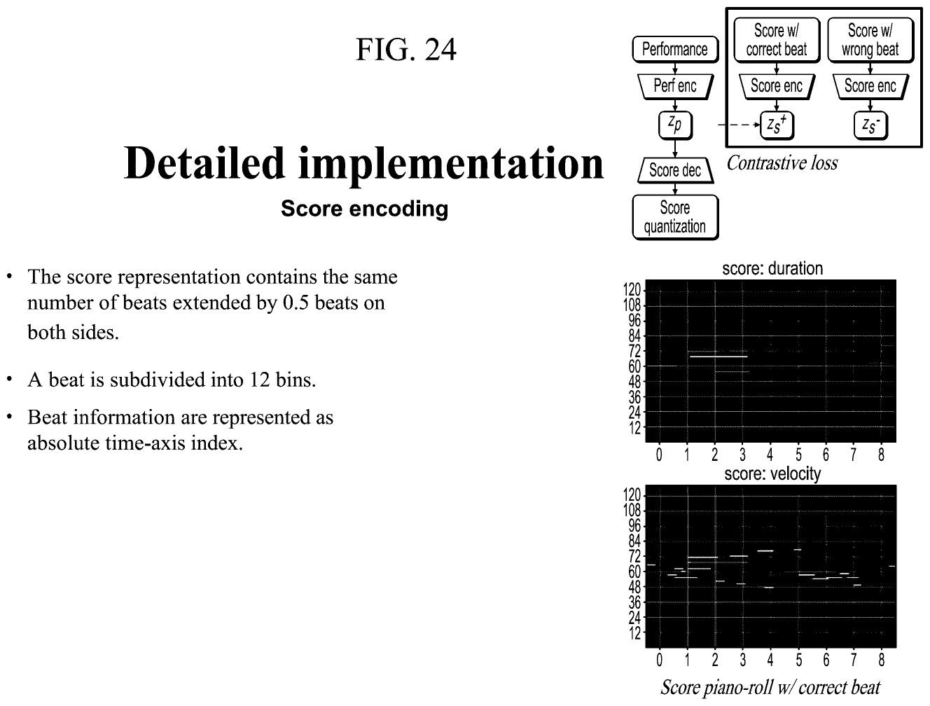

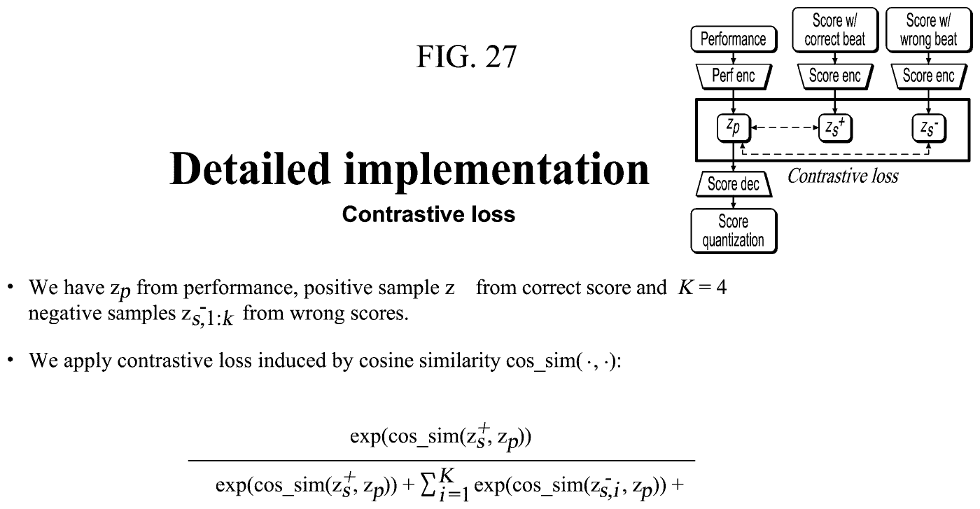

As shown in FIG. 24 to FIG. 26, the first encoder 321 converts the performance data Pd to the vector value Zp so that the value is close to Zs⁺ with multiple references to a vector value Zs⁺ when converting the data based on the score that the performer is assumed to have seen and played, and to a vector value Zs⁻ when converting the data different from the score that the performer is assumed to have seen and played. In this case, the formula shown in FIG. 27 is used. The vector value Zp is adjusted so that the formula shown in FIG. 27 becomes “=1”.

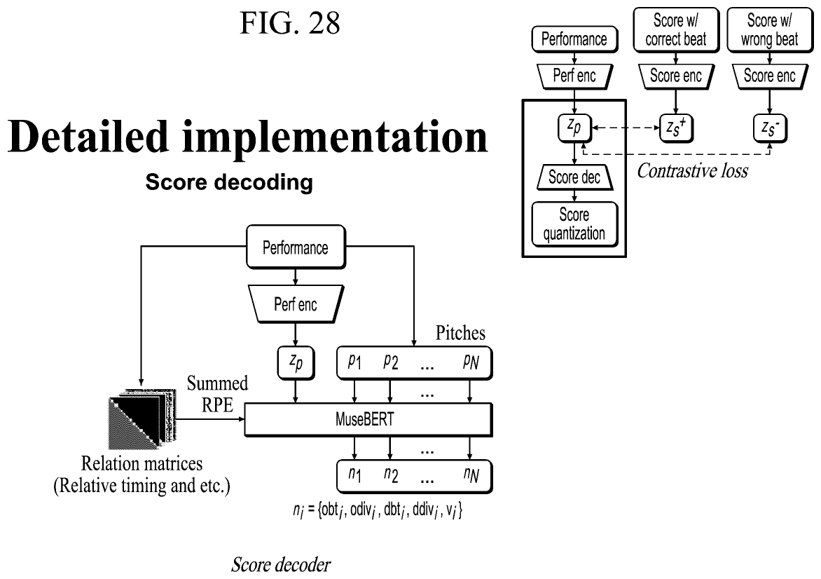

As shown in FIG. 28, the vector value Zp output from the first encoder 321 is input to the first decoder 322. In addition, the feature information based on the performance data Pd is also input to the first decoder 322. For example, MuseBERT is used for the first decoder 322.

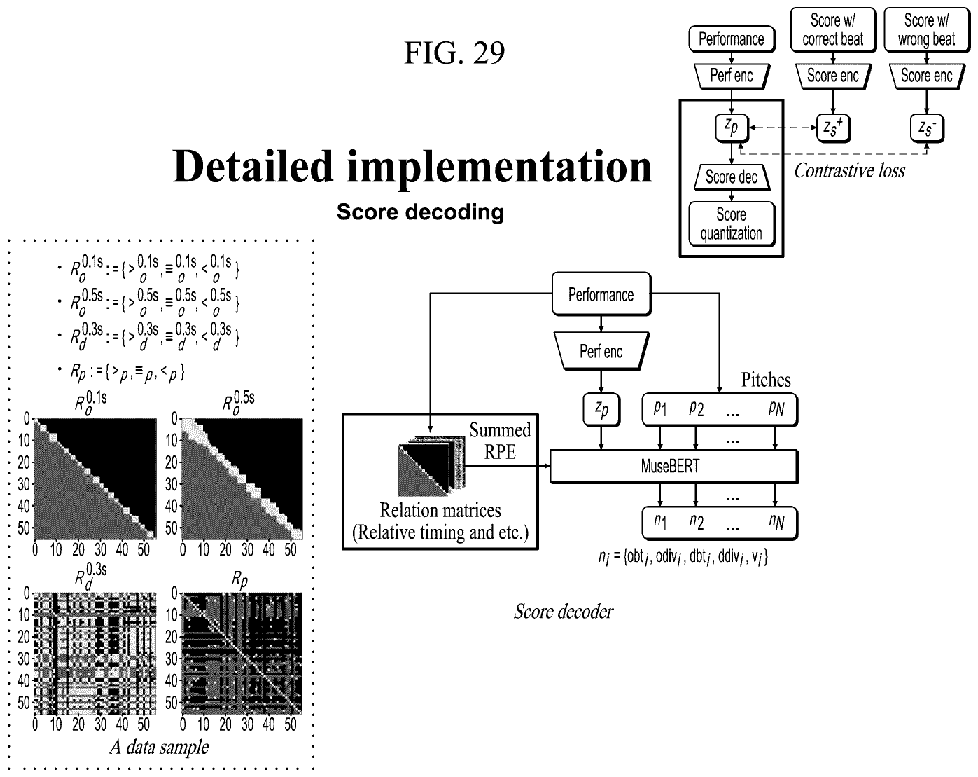

The feature information is generated by the feature extraction unit 323 of the first sound conversion unit 401 in the embodiment described above, and is information indicating the feature of the sound included in the performance data Pd. The feature information includes information indicating the pitch (hereinafter referred to as “pitch information”), information indicating the velocity (hereinafter referred to as “velocity information”), and information indicating the relative relationship between the sounds. The pitch information and the velocity information are associated with the time information, respectively. As shown in FIG. 29, the information indicating the relative relationship between the sounds indicates the relative relationship of onset (Rₒ), duration (R_{d}), pitch (Rₚ), etc. between a predetermined sound and another sound.

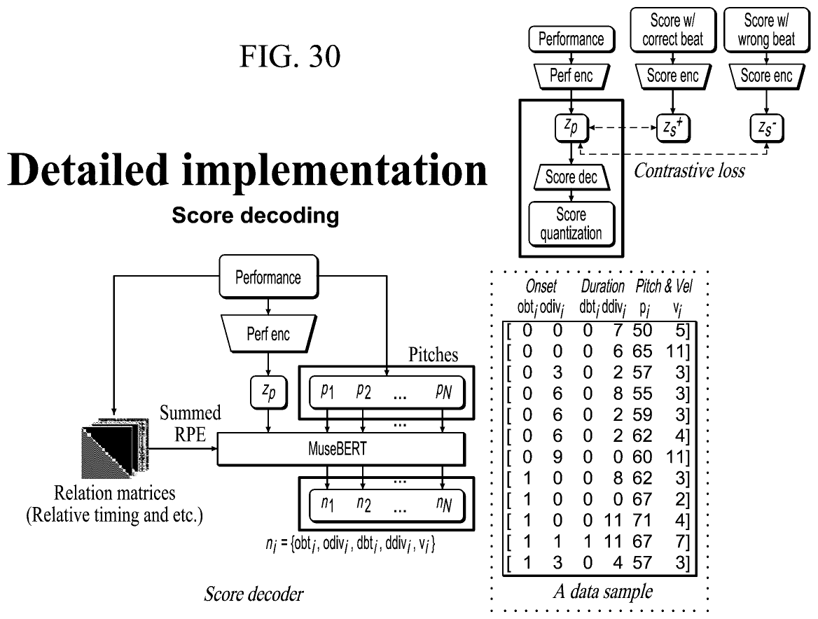

As shown in FIG. 30, the first decoder 322 outputs the first sound control data SC1 in response to the input. The first sound control data SC1 includes the pitch information (pitch), the duration information (duration), and the sound generation timing (onset; the beat and its position within the beat, or the position of a measure within the measure). The pitch information, the duration information, and the sound generation timing are associated with each other. The first sound control data SC1 may include intensity information (velocity).

According to FIG. 31, the quantization and beat tracking results with the ablation study, the beat tracking inference algorithm, and the self-updating training strategy are described below.

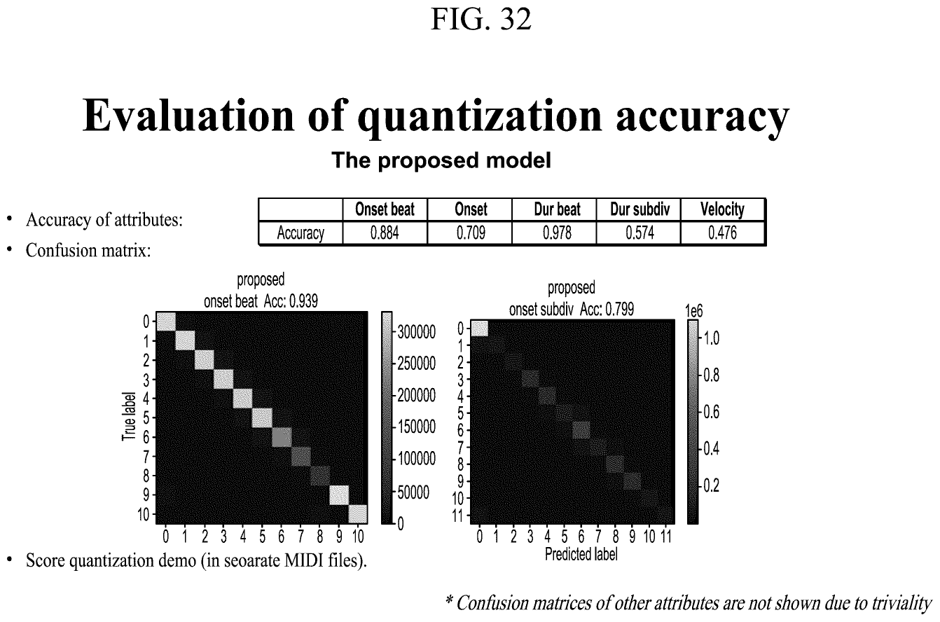

FIG. 32 shows the quantization accuracy with the model proposed here.

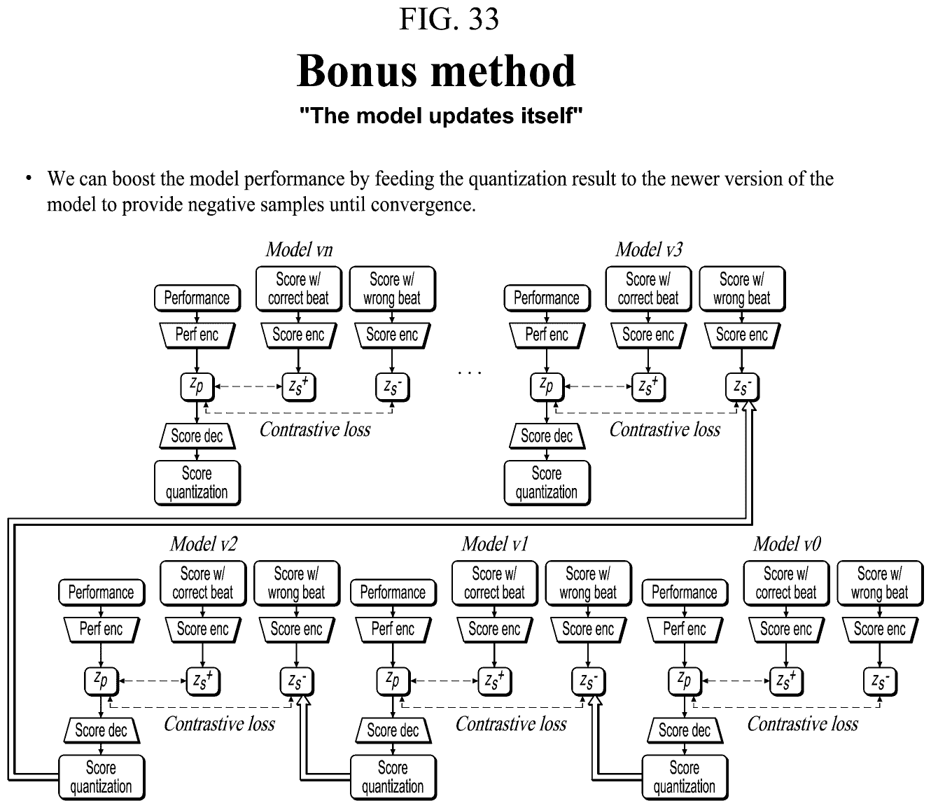

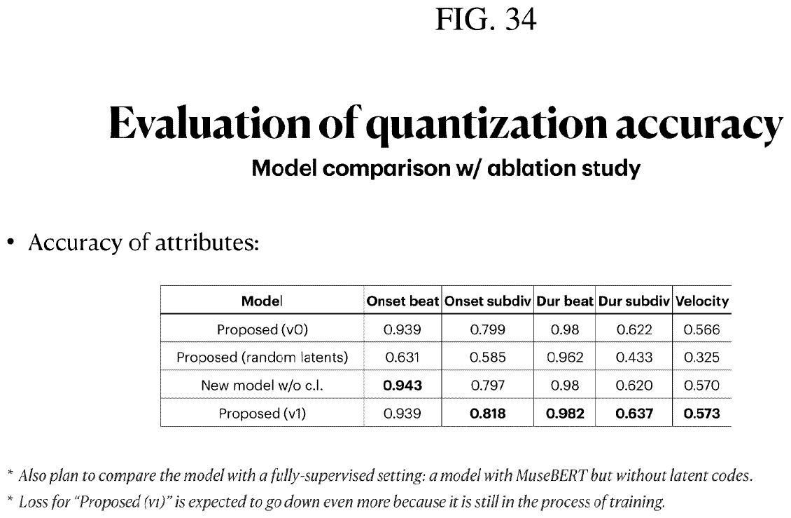

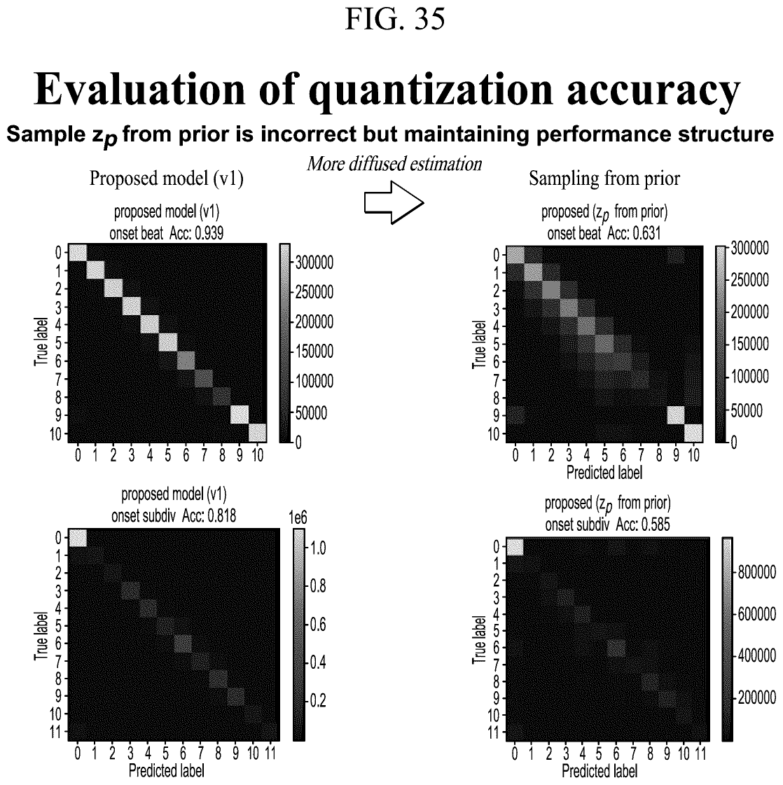

As shown in FIG. 33, the performance of the arithmetic model can be improved by feeding the quantization results to the newer version of the arithmetic model and providing a plurality of negative samples until convergence. FIG. 34 and FIG. 35 show the quantization accuracy with a model that uses the quantization results as negative samples.

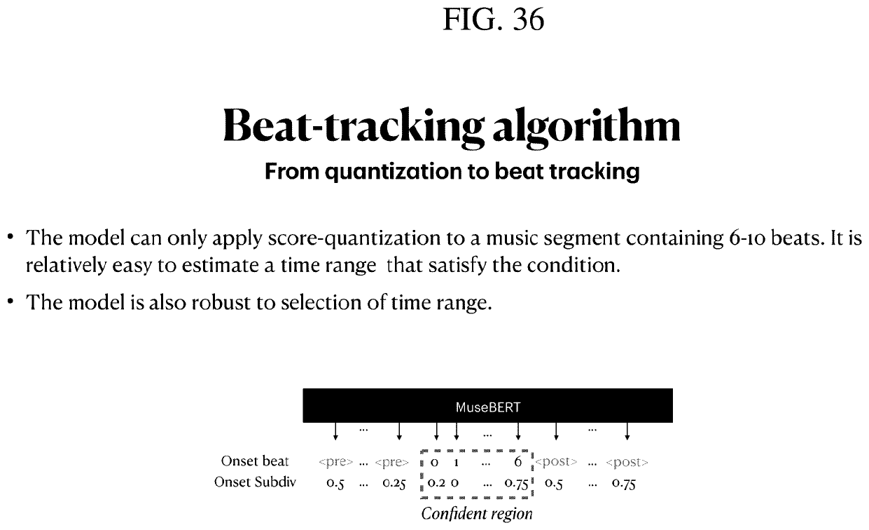

According to FIG. 36, the model can apply quantization only to a music segment containing 6 to 10 beats, it is relatively easy to estimate a time range that satisfies this condition, and the model is robust to the selection of a time range.

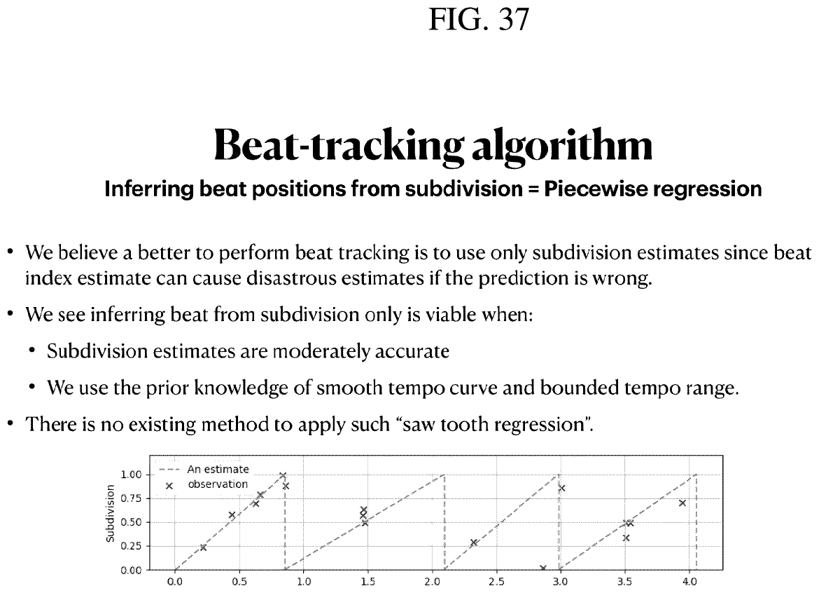

According to FIG. 37, it is believed that a better beat tracking is to use only subdivision estimates since beat estimation can cause disastrous estimates if the prediction is wrong. It is possible to estimate beats from subdivisions when the accuracy of detail estimation is moderate and when prior knowledge of a smooth tempo curve and a bounded tempo range is used. There is no existing method to apply a “saw tooth” regression such as the one shown in FIG. 37.

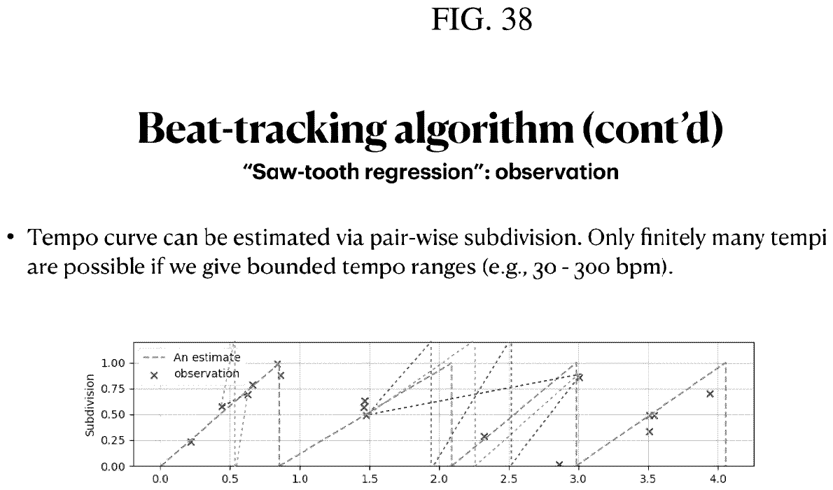

According to FIG. 38, the tempo curve can be estimated via pair-wise subdivision. Only a finite number of tempos are possible if we give bounded tempo ranges (e.g., 30 to 300 bpm).

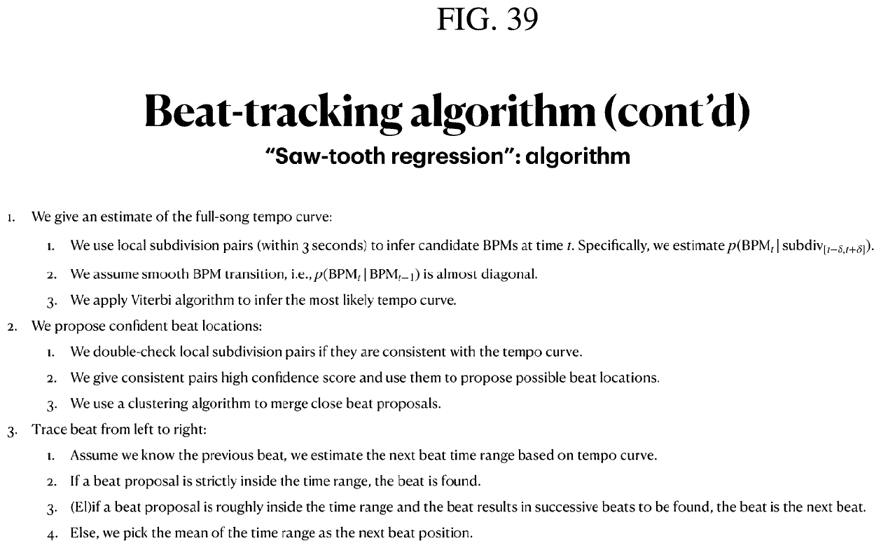

According to FIG. 39, the curve of the entire music is estimated first. It estimates local subdivision pairs (within 3 seconds) to estimate candidate BPMs, specifically, p (BPMₜ/subdiv_{[t-δ,t+δ]}), estimates smooth BPM transitions, that is, p (BPMₜ/BPMₜ₋₁) is assumed to be approximately diagonal, and involves applying the Viterbi algorithm, and estimate the most likely tempo curve. In addition, we propose a confident beat location. This involves double-checking local subdivision pairs if they are consistent with the tempo curve, giving consistent pairs a high confidence score, using it to propose possible beat positions, and using a clustering algorithm to merge close beat proposals. In addition, the beats are traced from left to right. This assumes that the previous beat is known, estimates the next beat range based on the tempo curve, and if a beat proposal is strictly inside the time range, the beat is found, if a beat proposal is roughly inside the time range and the beat is found successively, that beat is the next beat, otherwise, the mean of the time range is chosen as the next beat position.

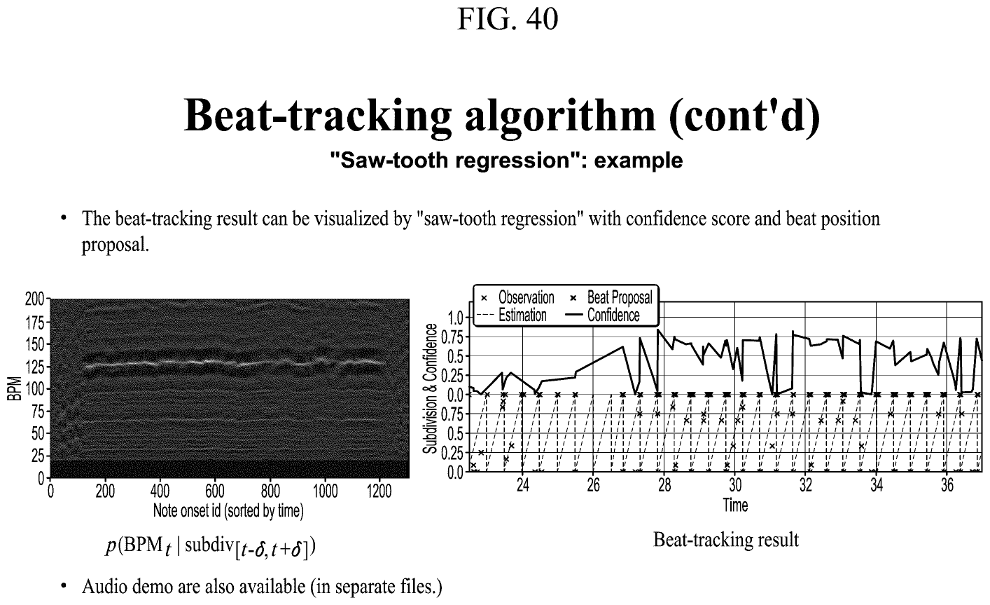

According to FIG. 40, the results of beat tracking can be visualized by saw tooth regression with a confidence score and beat position proposal.

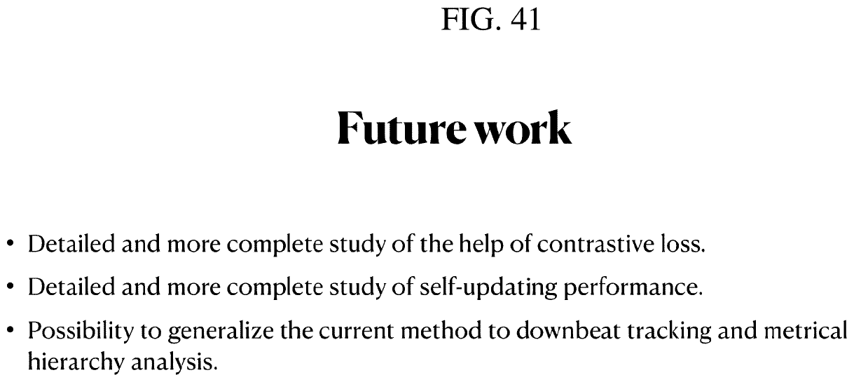

According to FIG. 41, future work includes a detailed and more complete study of the help of contrastive loss, a detailed and more complete study of self-updating performance, and the possibility of generalizing the current method to downbeat tracking and metrical hierarchy analysis.

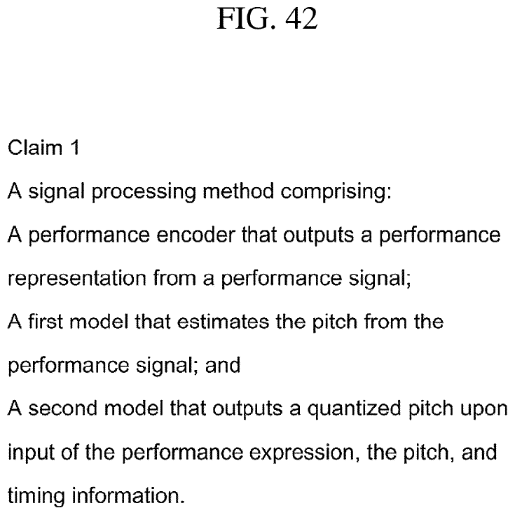

According to FIG. 42, the signal processing method described with reference to FIG. 17 to FIG. 41 can be viewed as consisting of a performance encoder that outputs a performance representation from the performance signal, a first model that estimates the pitch from the performance signal, and a second model that outputs a quantized pitch upon input of the performance representation, the pitch, and the timing information.

What is claimed is:

1. A data processing method for an electronic musical instrument, the data processing method comprising:
acquiring first sound control data, including pitch information, duration information, and a sound generation timing, from a first learned model to which performance data has been input;
inputting the first sound control data and a parameter corresponding to first user setting information into a second learned model; and
acquiring second sound control data from the second learned model.

2. The data processing method according to claim 1, wherein the first user setting information indicates a genre of performance desired by a user.

3. The data processing method according to claim 1, wherein the second learned model is acquired by machine learning a correlation between the first sound control data and the first user setting information and the second sound control data.

4. The data processing method according to claim 1, wherein
the first learned model is a learned model acquired by machine learning a correlation between the performance data and the first sound control data, and
the first sound control data also includes a correct beat and an incorrect beat.

5. The data processing method according to claim 1 further comprising extracting features from the performance data and inputting feature information indicating the features into the first learned model,
wherein the feature information includes pitch information, velocity information, and information indicating a correlation between sounds.

6. The data processing method according to claim 1, further comprising:
inputting the second sound control data into a third learned model acquired by machine learning to obtain score data from the second sound control data; and
acquiring the score data from the third learned model.

7. The data processing method according to claim 1, further comprising:
acquiring desired tempo information; and
generating a performance control signal based on the second sound control data and the desired tempo information.

8. The data processing method according to claim 1, further comprising:
inputting the second sound control data and a parameter corresponding to second user setting information into another learned model different from the first and second learned models; and
acquiring image control data corresponding to the sound generation timing from the other learned model.

9. The data processing method according to claim 1, further comprising comparing the performance data and the second sound control data to generate comparison information indicating a comparison result.

10. A non-transitory computer-readable storage medium storing a program executable by a computer to execute the data processing method according to claim 1.

11. A data processing method for an electronic musical instrument, the data processing method comprising:
acquiring first sound control data, including pitch information, duration information, and a sound generation timing, from a first learned model to which performance data has been input;
inputting the first sound control data into another learned model different from the first learned model; and
acquiring score data from the other learned model.

12. The data processing method according to claim 11, further comprising comparing the performance data and the first sound control data to generate comparison information indicating a comparison result.

13. A non-transitory computer-readable storage medium storing a program executable by a computer to execute the data processing method according to claim 11.

14. A data processing method for an electronic musical instrument, the data processing method comprising:
acquiring first sound control data, including pitch information, note value information, and a sound generation timing, from a first learned model to which performance data has been input;
inputting the first sound control data and a parameter corresponding to second user setting information into another learned model different from the first model; and
acquiring image control data corresponding to the sound generation timing from the other learned model.

15. The data processing method according to claim 14, wherein the second user setting information indicates a genre of action desired by a user.

16. The data processing method according to claim 14, wherein the other learned model is acquired by machine learning a correlation between the first sound control data and the second user setting information and the image control data.

17. A non-transitory computer-readable storage medium storing a program executable by a computer to execute the data processing method according to claim 14.
